(19) United States
(12) Patent Application Publication
(10) Pub. No.: US 2016/0274805 A1
(43) Pub. Date: Sep. 22, 2016

(54) DATA ARCHIVE SYSTEM

(71) Applicant: Hitachi-LG Data Storage, Inc., Tokyo (JP)

(72) Inventors: Chiyo OHNO, Tokyo (JP); Takakiyo YASUKAWA, Tokyo (JP); Shinji FUJITA, Tokyo (JP); Masayuki KOBAYASHI, Tokyo (JP)

(21) Appl. No.: 14/963,480

(22) Filed: Dec. 9, 2015

(30) Foreign Application Priority Data
Mar. 16, 2015 (JP) 2015-051596

(51) Int. Cl. G06F 3/06

(52) U.S. Cl. CPC G06F 3/0619; G06F 3/0653; G06F 3/065; G06F 3/0647; G06F 3/067; G06F 3/0689

(57) ABSTRACT

A data archive system includes a library apparatus that records and reproduces data on and from a plurality of recording media, and a server that manages the library apparatus. A control unit of the server determines whether quality inspection is performed on the entire surface of a recording medium housed in a recording medium housing unit or on a predetermined inspection region of the recording medium as an inspection range for inspecting recording quality of data recorded on the recording medium of the library apparatus, transmits a quality inspection execution request to a quality inspection execution unit of the library apparatus via a library I/F unit, and determines whether all data on the recording medium is transferred or some data is transferred as a transfer range in which the data is transferred on the basis of a result of the quality inspection which is received via the library I/F unit.

### BACKGROUND OF THE INVENTION

1. Field of the Invention

The present invention relates to a data archive system.

2. Background Art

As the related art of the present technology field, JP-A-2013-161500 discloses that “in a recording medium having recording surfaces on both sides, when a defect of one surface is detected, data recorded on the other surface is protected”, and “in a case where a defect during recording processing on a first recording surface or deterioration in reading quality is detected, data recorded on a second recording surface of the recording medium is copied to another recording medium”.

JP-A-2014-191839 discloses that “in an optical disc library device, in order to analyze a factor of quality deterioration of an optical disc and then to make a recovery corresponding to the factor, an optical drive measures a temperature in the optical disc library device, determines an inspection cycle for inspecting the optical disc on the basis of the measured temperature, and inspects the recording quality of the optical disc, stored in the optical disc library device and having been recorded on, on the basis of the determined cycle”.

### SUMMARY OF THE INVENTION

In a case where an optical disc on which data is recorded is required to be preserved for a long period of time, it is necessary to periodically perform quality inspection in order to prevent the data from being unreadable due to deterioration in recording quality of the data on the recording medium.

In a case where it is determined that the recording quality is deteriorated and thus the data is required to be transferred to a new optical disc as a result of the quality inspection, if all the data on the optical disc is transferred to the new optical disc at all times, there is a problem in that optical discs prepared for the transfer become insufficient, or an optical disc for data recording is required to be used for the transfer and thus recordable data capacity is reduced in a system.

An object of the present invention is to provide a data archive system which analyzes, for example, a pattern or elapsed years of a quality deteriorated portion of an optical disc, or the extent of quality deterioration, determines whether all data on the disc is transferred or only data corresponding to the deteriorated portion is transferred according to the extent of deterioration, and can thus efficiently prevent the optical disc from being used wastefully.

In order to solve the problem, for example, the configurations recited in the claims are employed.

According to the present invention, it is possible to provide the data archive system which can efficiently prevent an optical disc from being wastefully used and can ensure data reading for a long period of time.

Objects, configurations, and effects other than the above description will become apparent through description of the following embodiments.

### BRIEF DESCRIPTION OF THE DRAWINGS

FIG. 1 is a block diagram illustrating an example of a configuration of the entire system of the present invention.

FIG. 2 is a block diagram illustrating an example of a configuration of a server.

FIG. 3 is a block diagram illustrating an example of a configuration of an application server.

FIG. 4 is a block diagram illustrating an example of a configuration of an apparatus management server.

FIG. 5 illustrates an example of a recording medium storing table (which is stored in a storage unit of a portable recording apparatus).

FIG. 6 illustrates an example of a portable recording apparatus configuration management table (which is stored in a state management unit of the portable recording apparatus).

FIG. 7 illustrates an example of a system configuration management table (a configuration management unit of the server).

FIG. 8 illustrates an example of a data management table (a file management unit of the server).

FIG. 9 illustrates an example of a job management table (a job execution management unit of the apparatus management server).

FIG. 10 illustrates an example of an apparatus configuration management table.

FIG. 11 illustrates an example of a capacity management table (a capacity management unit of the apparatus management server).

FIG. 12 illustrates an example of an optical disc management table (a configuration management unit and a quality inspection control unit of the server).

FIG. 13 is a flowchart illustrating details of an example of a temperature monitoring process (quality inspection information management unit of the apparatus management server).

FIG. 14 illustrates an example of an inspection cycle table (a relationship between the environmental temperature and the inspection cycle).

FIG. 15 is a diagram illustrating life prediction for an optical disc.

FIG. 16 illustrates an example of a quality inspection schedule table (a quality inspection schedule generation unit of the apparatus management server)

FIG. 17 illustrates an example of an inspection region of the optical disc.

FIG. 18 is a diagram illustrating a relationship between an inspection range and an evaluation region in an optical disc surface.

FIG. 19 is a flowchart illustrating an example of a quality inspection job execution process (the job execution management unit of the apparatus management server).

FIG. 20 is a flowchart illustrating an example of a quality inspection execution process (the quality inspection control unit of the server).

FIG. 21 is a flowchart illustrating an example of a quality inspection result analysis process (a quality result analysis unit of the server).

FIG. 22 is a flowchart illustrating an example of a data transfer process (a data transfer control unit of the server).

FIG. 23 is a flowchart illustrating an example of the data transfer process (the data transfer control unit of the server).

FIG. 24 illustrates an example of a quality inspection information table (the quality inspection control unit of the server).

FIG. 25 illustrates a screen example of displaying an optical disc usage situation (the apparatus management server).

FIG. 26 illustrates a screen example of displaying an optical disc deterioration situation (the apparatus management server).

### DETAILED DESCRIPTION OF THE INVENTION

Hereinafter, Examples will be described with reference to the drawings.

### EXAMPLE 1

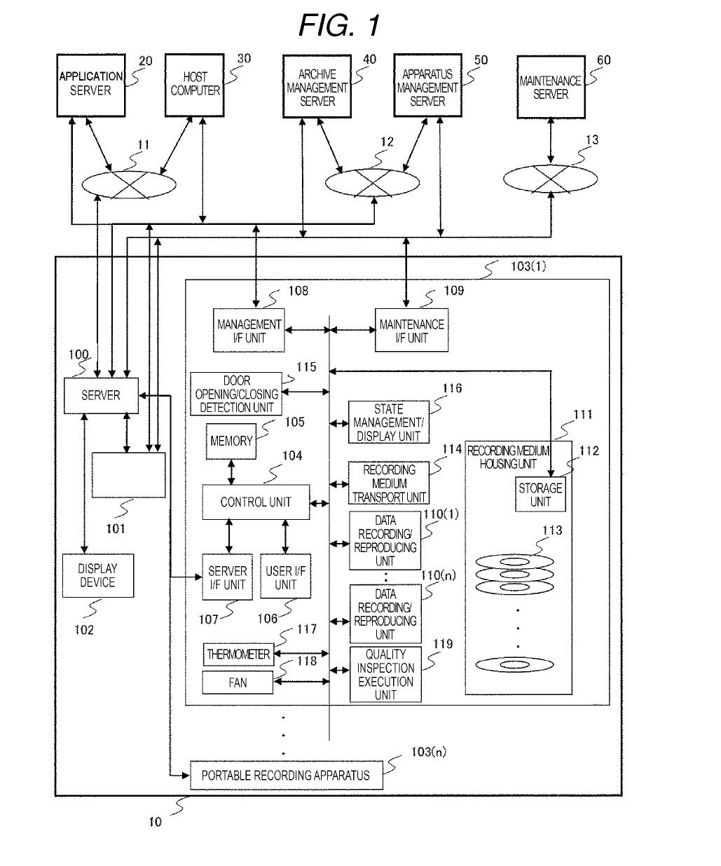

FIG. 1 is a diagram illustrating a configuration example of the entire system.

The present system is constituted of apparatuses such as a data library system 10, an application server 20, a host computer 30, an archive management server 40, an apparatus management server 50, and a maintenance server 60.

The data library system 10, the application server 20, and the host computer 30 are connected to each other via a data network 11 in order to transmit and receive files, objects, and the like.

The data library system 10, the application server 20, the host computer 30, the archive management server 40, and the apparatus management server 50 are connected to each other via a management network 12 in order to transmit and receive information for performing operation and management of each apparatus.

The data library system 10, the archive management server 40, the apparatus management server 50, and the maintenance server 60 are connected to each other via a maintenance network 13 in order to transmit and receive information for performing maintenance of each apparatus. Although not illustrated, the application server 20 may be connected to the host computer 30.

Here, the data network 11, the management network 12, and the maintenance network 13 use any protocol such as Fiber Channel (FC) or Internet Protocol (IP). The data network 11 and the management network 12 may be the same network. Each apparatus may be connected to the network in a plurality.

A server 100 of the data library system 10 and the apparatus management server 50 may operate on the same apparatus.

The host computer 30 is a terminal which is operated by a company or a personal user, and is a personal computer (PC), a smart phone, a tablet PC, a workstation, or the like.

The application server 20 is server which provides various applications or services to a company or a personal user, such as a file server, a mail server, or a video server storing data which is generated or edited by the host computer 30. Although not illustrated, a storage (a hard disk drive (HDD) or a solid state drive (SSD) a hybrid type storage having both of the drives, or the like) storing the data is built in the server or is externally attached thereto.

The data library system 10 is a storage equipped with a portable recording medium, and is a storage system which stores data treated by the host computer 30 or the application server 20 for the purpose of backup or archive.

The archive management server 40 is a server installed with archive software which provides a backup or archive function is installed, and archives data in the data library system 10 from the application server 20 in the present example. The server has a data movement policy setting function or a job management function for periodically performing backing up or archiving. The server may also have a function of searching for data which is backed up or archived.

The apparatus management server 50 is a server installed with operation management software which is required to operate and manage the respective apparatuses such as the data library system 10, the application server 20, the host computer 30, and the archive management server 40 via the management network 12 is installed, and is a server which manages a configuration, state, and capacity of each apparatus.

The maintenance server 60 is a server installed with a tool or software which is required to perform maintenance of the data library system 10, the archive management server 40, and the apparatus management server 50 via the maintenance network 13. In a case where an error such as a failure occurs in each apparatus, the maintenance server 60 is notified of the error via the maintenance network 13. It is possible to acquire log information of each apparatus from the maintenance server 60 as necessary.

Hereinafter, a description will be made of a configuration of each apparatus with reference to the drawings.

The data library system 10 includes one or more servers 100, a block storage 101, a display device 102, and one or more portable recording apparatuses 103. Each of the servers 100 is connected to the block storage 101, the display device 102, and one or more portable recording apparatuses 103 via a network (for example, FC or IP) using any protocol. In FIG. 1, the display device 102 is built into the data library system 10, but may be externally attached thereto (the outside of the system). The block storage 101 is constituted of any type of device such as one or more hard disk drives (HDDs) or one or more solid state drives (SSDs), and may include a plurality of types of devices.

Each of the portable recording apparatuses 103 includes a control unit 104, a memory 105, a user I/F unit 106, a server I/F unit 107, a management I/F unit 108, a maintenance I/F unit 109, one or more data recording/reproducing units 110, a recording medium housing unit ill, a storage unit 112 added to the recording medium housing unit, one or more optical discs 113, a recording medium transport unit 114, a door opening/closing detection unit 115, a state management/display unit 116, a thermometer 117, a fan 118, and a quality inspection execution unit 119.

The control unit 104 controls the respective units of the portable recording apparatus 103 according to various programs in the memory 105.

The memory 105 stores various operating systems (OSs), programs, and information, and stores, for example, programs or setting information for controlling the control unit 104 of the portable recording apparatus 103.

The user I/F unit 106 provides means required for a user to operate the portable recording apparatus 103, such as various switches.

The server I/F unit 107 transmits and receives data which is recorded or reproduced, or various control commands or notifications between the server 100 and the portable recording apparatus 103.

The management I/F unit 108 transmits and receives data, or various control commands or notifications related to operation management to and from the apparatus management server 50 or the archive management server 40 via the management network 12.

The maintenance I/F unit 109 transmits and receives data, or various control commands or notifications related to maintenance to and from the maintenance server 60 via the maintenance network 13.

Each of the data recording/reproducing units 110 records data on the optical disc 113 or reproduces the data from the optical disc. The data recording/reproducing unit 110 is attachable and detachable, and may be detached from the portable recording apparatus 103, for example, when a failure or the like occurs, and another data recording/reproducing unit 110 may be attached to the portable recording apparatus 103.

The recording medium housing unit 111 houses one or more optical discs. In the present example, the recording medium housing unit 111 includes a plurality of slots each housing a single optical disc 113. The recording medium housing unit 111 may house superposed optical discs without including the slots. The recording medium housing unit 111 is attachable and detachable. For example, when data has been recorded on all the optical discs, each recording medium housing unit may be extracted out of the portable recording apparatus, and another recording medium housing unit housing unused discs may be inserted into the portable recording apparatus. In FIG. 1, the recording medium housing unit 111 is illustrated alone, but may be provided in a plurality in the portable recording apparatus. For example, the plurality of recording medium housing units may be used so as to be divided according to usage such as housing units of unused discs and housing units of discs on which data has been recorded.

The storage unit 112 stores information regarding the recording medium housing unit 111 or information required to control the recording medium housing unit 111. The storage unit 112 is constituted of a rewritable nonvolatile semiconductor memory or the like in which data is not erased even if power is not supplied.

As the optical disc 113, an optical disc such as the Blu-ray disc™ is used in the present example, and a plurality of optical discs 113 are housed in the recording medium housing unit 111. A hologram disc or the like may be used as the optical disc 113. The hologram disc is a recording medium on which data is recorded as hologram by using photopolymer (photosensitive resin) in a recording layer. Regarding the hologram, a chemical reaction of photopolymer occurs due to brightness and darkness of light caused by an interference fringe pattern incident to the recording layer, and thus the hologram is recorded. In the present example, the optical disc is described as an example of a recording medium, but the present invention is applicable to other portable recording media (for example, a tape).

The recording medium transport unit 114 extracts the optical disc 113 from the recording medium housing unit 111, transports the optical disc, and loads the optical disc on the data recording/reproducing unit 110. Alternatively, the optical disc 113 is received from the data recording/reproducing unit 110, transported, and housed in the recording medium housing unit 111.

The door opening/closing detection unit 115 detects opening and closing of a door (not illustrated) of the portable recording apparatus, and delivers detected information to the control unit 104. The door is opened and closed when the recording medium housing unit is inserted into and extracted out of the portable recording apparatus.

The state management/display unit 116 collects and manages a status such as an operation situation or error information of each unit of the portable recording apparatus 103, and outputs the status to an internal or external liquid crystal display or a light emitting diode (LED) so as to display the status to a user.

The thermometer 117 measures and monitors the temperature in the portable recording apparatus 103. If a temperature acquisition request is received from the control unit 104, the thermometer 117 measures the current temperature and notifies the control unit 104 of the measurement result.

The fan 118 reduces the temperature in the portable recording apparatus 103 in response to an instruction from the control unit 104. In a case where a result measured by the thermometer 117 exceeds a predetermined threshold value (for example, 25 degrees Celsius), the fan is operated in response to an instruction from the control unit 104.

The quality inspection execution unit 119 sets a predetermined optical disc housed in the recording medium housing unit 111 in the data recording/reproducing unit 110 and performs quality inspection on the optical disc in response to an instruction from the control unit 104. A notification of an inspection result is sent to the control unit 104. Here, the quality inspection execution unit 119 may hold the quality inspection result or the temperature measured by the thermometer 117, acquired from the control unit 104, in the memory 105, the storage unit 112, the block storage 101, or the like.

Although not illustrated, the portable recording apparatus may include an encryption/decryption unit which encrypts data to be stored and decrypts data to be read, or a compression unit which compresses data to be stored and decompresses data to be read.

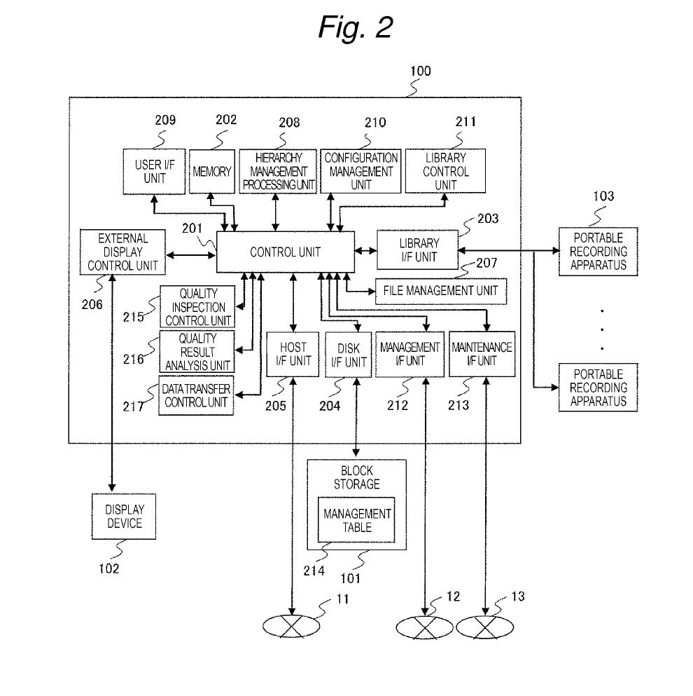

Next, with reference to FIG. 2, a description will be made of a configuration example of the server 100 of the data library system 10.

The server 100 includes a control unit 201, a memory 202, a library I/F unit 203, a disk I/F unit 204, a host I/F unit 205, an external display control unit 206, a file management unit 207, a hierarchy management processing unit 208, a user I/F unit 209, a configuration management unit 210, a library control unit 211, a management I/F unit 212, a quality inspection control unit 215, a quality result analysis unit 216, and a data transfer control unit 217.

The control unit 201 controls the respective units of the server 100 according to various programs stored in the memory 202.

The memory 202 stores various OSs, programs, and information, and stores, for example, programs or setting information for controlling the control unit 201. In addition, status information or the like sent from the portable recording apparatus 103 is recorded in the memory.

The library I/F unit 203 performs control related to transmission and reception of data or control information between the portable recording apparatus 103 and the server 100.

The disk I/F unit 204 performs control related to transmission of data to the block storage 101 on the basis of a standard such as Serial Advanced Technology Attachment (SATA) or Small Computer System Interface (iSCSI).

The host I/F unit 205 transmits and receives data, or various control commands or notifications to and from the application server 20 or the host computer 30 via the data network 11. For example, a general purpose interface such as network file system (NFS), Common Internet File System (CIFS/Samba), Representational State Transfer (REST), or File Transfer Protocol (FTP) is used.

The external display control unit 206 displays information managed by the configuration management unit 210, the hierarchy management processing unit 208, and the file management unit 207, or the status information in the data library system 10, on the display device 102.

The file management unit 207 manages information regarding all data stored in the block storage 101 and the portable recording apparatus 103.

The hierarchy management processing unit 208 selects movement target data among the stored in the block storage 101 in conjunction with the file management unit 207 according to any policy managed by the hierarchy management processing unit 208 or the memory 202. The movement target data is read via the disk I/F unit, and is moved to the portable recording apparatus 103 via the library I/F unit so as to be recorded on the optical disc 113. After all target data is recorded, the hierarchy management processing unit 208 groups the movement target data in the block storage 101 and erases the data body. The hierarchy management processing unit 208 may be operated according to movement policy of the archive management server 40 by communicating with a hierarchy management processing unit of the archive management server 40 which will be described later via the management network 12. For example, data stored in the application server 20 is read via the data network 11 (in conjunction with a hierarchy management processing unit 310 of the application server 20 which will be described later as necessary), and is moved to the block storage 101 or the portable recording apparatus 103. At this time, grouping of movement target data in the application server 20 or erasing of a data body is performed by either the hierarchy management processing unit 208 or the archive management server 40. In addition, the hierarchy management processing unit 208 may be operated according to policy managed by the hierarchy management processing unit 310 of the application server 20.

The user I/F unit 209 provides means required for a user to control the server by using an input device such as an externally attached mouse or keyboard or to control each portable recording apparatus on the basis of various information displayed on the display device 102.

The configuration management unit 210 manages a form, a manufacturer name, a specification, an operation state, and the like of each unit constituting the data library system 10, that is, the display device 102, the block storage 101, the portable recording apparatus 103, a network switch (not illustrated), or a power source chassis (not illustrated).

The library control unit 211 performs selection of the portable recording apparatus 103 or the optical disc 113 to be used, or recording or reproducing via the library I/F unit 203 in response to an instruction from the hierarchy management processing unit 208.

The management I/F unit 212 transmits and receives data, or various control commands or notifications related to operation management to and from the apparatus management server 50 or the archive management server 40 via the management network 12.

The maintenance I/F unit 213 transmits and receives data, or various control commands or notifications related to maintenance to and from the maintenance server 60 via the maintenance network 13.

The quality inspection control unit 215 instructs the quality inspection execution unit 119 of the portable recording apparatus 103 to perform quality inspection on a predetermined optical disc via the library I/F unit 203 in order to inspect recording quality deterioration of the optical discs housed in the portable recording apparatus 103. The quality inspection control unit 215 forwards a result of the quality inspection received from the library I/F unit 203 to the quality result analysis unit 216, and instructs the data transfer control unit 217 to transfer data on the deteriorated optical disc to a new optical disc in a case where it is determined that transfer of the data is necessary.

The quality result analysis unit 216 analyzes the quality inspection result received from the quality inspection control unit 215 so as to analyze the pattern of a quality deteriorated portion, years elapsed since data was recorded, and the extent of quality deterioration, determines whether all data on the disc is to be transferred or only data corresponding to the deteriorated portion is to be transferred, and notifies the quality inspection control unit 215 of an analysis result.

The data transfer control unit 217 selects a new optical disc and copies the data thereto in response to an instruction from the quality inspection control unit 215 in a case where all the data on the deteriorated optical disc is transferred. In a case where only necessary data is transferred, a transfer target portion is determined and is copied to a predetermined position in the block storage 101.

Here, the hierarchy management processing unit 208 illustrated in FIG. 2 may be integrated with the hierarchy management processing unit of the archive management server 40, and may be operated on a server which is different from the server 100.

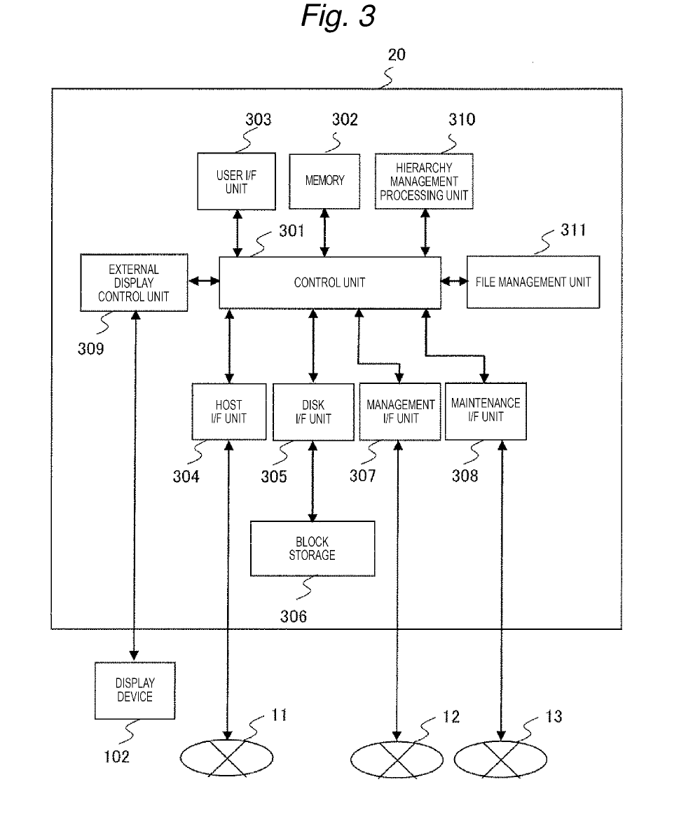

Next, with reference to FIG. 3, a description will be made of a configuration of the application server 20.

The application server 20 includes a control unit 301, a memory 302, a user I/F unit 303, a host I/F unit 304, a disk I/F unit 305, a block storage 306, a management I/F unit 307, a maintenance I/F unit 308, an external display control unit 309, a hierarchy management processing unit 310, and a file management unit 311.

The control unit 301 controls the respective units of the application server 20 according to various programs stored in the memory 302.

The memory 302 stores various OSs, programs, and information, and stores, for example, programs or setting information for controlling the control unit 301.

The user I/F unit 303 provides manes required for a user to control the application server 20 by using an input device such as an externally attached mouse or keyboard, or a remote control on the basis of various information displayed on the display device 102.

The host I/F unit 304 is connected to the host computer 30 or the data library system 10 via the data network 11.

The disk I/F unit 305 performs control related to transmission of data to the block storage 306 on the basis of a standard such as SATA or SCSI.

The block storage 306 stores data which is generated or edited by the application server 20, or data received from the host computer 30. The block storage 306 is constituted of any type of device such as HDDs or SSDs, and may include a plurality of types of devices. In FIG. 3, the block storage 306 is built into the application server 20, but may be externally attached thereto, and may be both built thereinto and externally attached thereto. The host computer 30 and the application server 20 may share the block storage 306.

The management I/F unit 307 transmits and receives data, or various control commands or notifications related to operation management to and from the apparatus management server 50 or the archive management server 40 via the management network 12.

The maintenance I/F unit 308 transmits and receives data, or various control commands or notifications related to maintenance to and from the maintenance server 60 via the maintenance network 13.

The external display control unit 309 displays information managed by the hierarchy management processing unit 310 and the file management unit 311, or the status information in the application server 20, on the display device 102.

The hierarchy management processing unit 310 selects movement target data among the stored in the block storage 306 in conjunction with the file management unit 311 according to any policy managed by the hierarchy management processing unit 310 or the memory 302. The movement target data is read via the disk I/F unit, and is transmitted to the data library system 10 via the host I/F unit 304. After all target data is transmitted, the hierarchy management processing unit 208 groups the movement target data in the block storage 306 and erases the data body. The hierarchy management processing unit 310 may be operated according to movement policy of the archive management server 40 by communicating with a hierarchy management processing unit of the archive management server 40 which will be described later via the management network 12. For example, data stored in the block storage 306 is read via the data network 11 in response to an instruction from the hierarchy management processing unit of the archive management server 40, and is transmitted to the data library system 10. At this time, grouping of movement target data in the application server 20 or erasing of a data body is performed by either the hierarchy management processing unit 310 or the hierarchy management processing unit of the archive management server 40.

The file management unit 311 manages information regarding data stored in the block storage 306.

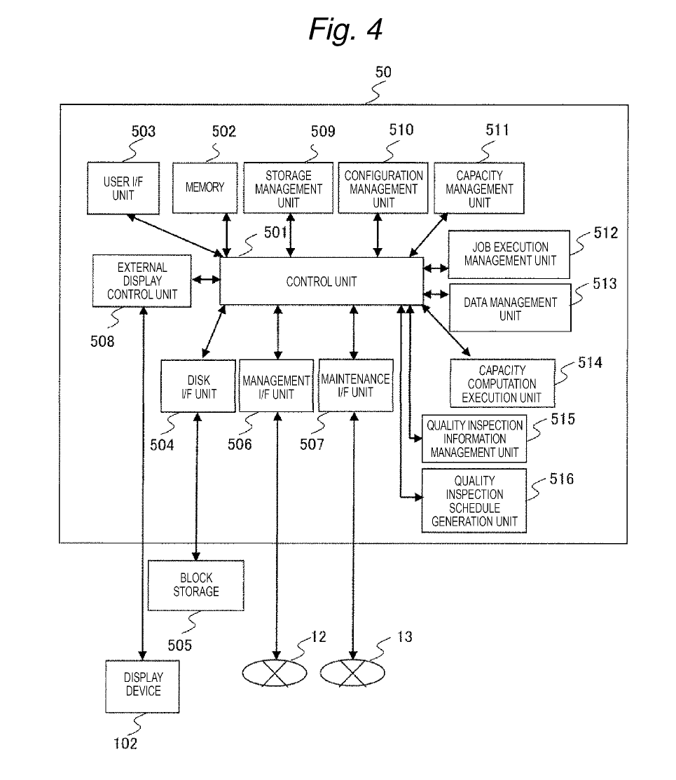

Next, with reference to FIG. 4, a description will be made of a configuration example of the apparatus management server 50.

The apparatus management server 50 includes a control unit 501, a memory 502, a user I/F unit 503, a disk I/F unit 504, a block storage 505, a management I/F unit 506, a maintenance I/F unit 507, an external display control unit 508, a storage management unit 509, a configuration management unit 510, a capacity management unit 511, a job execution management unit 512, a data management unit 513, a capacity computation execution unit 514, a quality inspection information management unit 515, and a quality inspection schedule generation unit 516.

The control unit 501 controls the respective units of the apparatus management server 50 according to various programs stored in the memory 502.

The memory 502 stores various OSs, programs, and information, and stores, for example, programs or setting information for controlling the control unit 501.

The user I/F unit 503 provides manes required for a user to control the apparatus management server 50 by using an input device such as an externally attached mouse or keyboard, or a remote control on the basis of various information displayed on the display device 102.

The disk I/F unit 504 performs control related to transmission of data to the block storage 505 on the basis of a standard such as SATA or SCSI.

The block storage 505 stores data which is generated or edited by the apparatus management server 50, data managed by the storage management unit 509, the configuration management unit 510, or the capacity management unit 511 which will be described later, information regarding a job managed by the job execution management unit 512, and information generated or edited by the data management unit 513. The block storage 505 is constituted of any type of device such as HDDs or SSDs, and may include a plurality of types of devices. In FIG. 4, the block storage 505 is built into the apparatus management server 50, but may be externally attached thereto and may be both built thereinto and externally attached thereto.

The management I/F unit 506 transmits and receives data, or various control commands or notifications related to operation management to and from the application server 20, the host computer 30, the archive management server 40, and the server 100, the block storage 101, and the portable recording apparatus 103 of the data library system 10 via the management network 12.

The maintenance I/F unit 507 transmits and receives data, or various control commands or notifications related to maintenance to and from the maintenance server 60 via the maintenance network 13.

The external display control unit 508 displays information or statuses managed by the storage management unit 509, the configuration management unit 510, the capacity management unit 511, the job execution management unit 512, and the data management unit 513, or the status information in the apparatus management server 50, on the display device 102.

The storage management unit 509 manages information regarding the respective apparatuses (the application server 20, the host computer 30, the archive management server 40, and the server 100, the block storage 101, and the portable recording apparatus 103 of the data library system 10) which are connected thereto via the management I/F unit 506.

The configuration management unit 510 manages configuration information regarding the respective apparatuses which are connected thereto via the management I/F unit 506.

The capacity management unit 511 manages storage capacities of the respective apparatuses which are connected thereto via the management I/F unit 506.

The job execution management unit 512 manages and executes the content of jobs performed in the respective apparatuses which are connected thereto via the management I/F unit 506.

The data management unit 513 manages information regarding files or data in the respective apparatuses which are connected thereto via the management I/F unit 506.

The capacity computation execution unit 514 computes an estimate of system processing performance or capacity required to perform a backup and/or archive service(s) in a case where a new storage system is introduced or added. An execution result is output to the display device 102 via the external display control unit 508 as necessary.

The quality inspection information management unit 515 acquires a result of quality inspection which is periodically performed in order for an optical disc on which data is recorded to be used for a long period of time or an analysis result from the data library system 10, and holds and manages the results in the memory 502 or the block storage 505. In a case where a manager gives an instruction for displaying a quality inspection situation via the user I/F unit 503, the quality inspection information management unit 515 displays the result of the quality inspection or the analysis result on the display device 102 via the external display control unit 508. In addition, in a case where a request for acquiring quality inspection information is received from the maintenance server 60 via the maintenance I/F unit 507, the quality inspection information management unit 515 transmits the result of quality inspection or the analysis result thereto via the maintenance I/F unit 507. The quality inspection information management unit 515 may periodically notify the maintenance server 60 of the quality inspection information. The quality inspection information management unit 515 manages the temperature of the data library system 10.

The quality result analysis unit 216 generates a schedule for performing quality inspection on optical discs housed in the data library system 10, and registers the schedule in the job execution management unit 512.

Next, with reference to the drawings, a description will be made of a configuration of an information table managed by each apparatus.

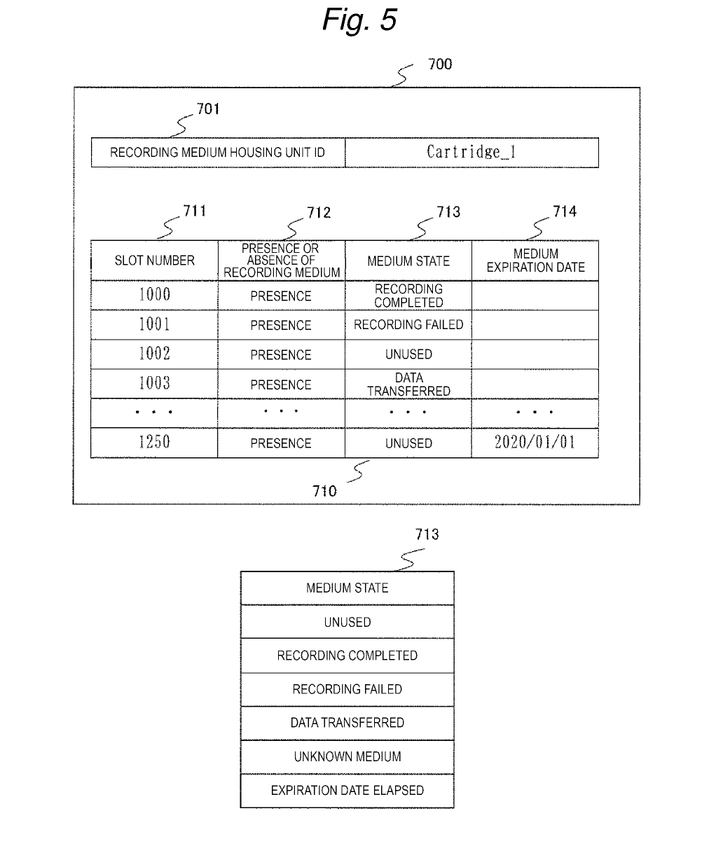

First, with reference to FIG. 5, a description will be made of a configuration example of a recording medium housing table 700 managed by the storage unit 112 of the portable recording apparatus 103 of the data library system 10.

The recording medium housing table 700 contains recording medium housing unit information 701 which is information regarding the recording medium housing unit 111, and slot information 710 which is information regarding a slot which houses a single optical disc.

The recording medium housing unit information 701 is an identifier for uniquely identifying the recording medium housing unit 111. The identifier does not overlap identifiers of other recording medium housing units 111 of the data library system.

The slot information 710 is formed of a slot number 711, the presence or absence of recording medium 712, a medium state 713, and a medium expiration date 714.

The slot number 711 is a value indicating a position of a slot where the optical disc 113 is housed in the recording medium housing unit 111. The control unit 104 of the portable recording apparatus 103 holds the slot number 711 and returns the optical disc 113 to an original slot position in a case of transporting the optical disc from the recording medium housing unit 111 to the data recording/reproducing unit 110 by using the recording medium transport unit 114.

The presence or absence of recording medium 712 is a value indicating whether or not the optical disc 113 is put into the slot position indicated by the slot number 711, and has a value of “presence (1)” or “absence (0)”.

The medium state 713 is a value indicating a state of the optical disc 113 housed at the slot position indicated by the slot number 711, and includes states such as “unused”, “recording completed”, “recording failed”, “data transferred”, “unknown medium”, and “expiration date elapsed”. The “unused” state indicates that the optical disc 113 housed in the slot is not used and can record data. The “recording completed” state indicates that recording of data on the optical disc 113 and inspection on the recording are normally completed. The “recording failed” state indicates that recording of data on the optical disc 113 or inspection thereof has failed. In this case, data recorded on the optical disc 113 cannot be reproduced by the data recording/reproducing unit 110. The “data transferred” state indicates that data recorded on the optical disc 113 is copied to another optical disc, and thus the optical disc 113 is not necessary. The “unknown medium” state indicates that the data recording/reproducing unit 110 cannot perform recording or reproduction on the optical disc 113 housed in the slot. The “expiration date elapsed” state indicates that the expiration date has elapsed in a state in which the optical disc 113 housed in the slot is not used, and thus data cannot be recorded on the disc.

The medium expiration date 714 is the expiration date until which the unused optical disc 113 can be used to record data, and is provided by the manufacturer of an optical disc. In a case where the optical disc 113 is shipped in a state of being inserted into the recording medium housing unit 111, the expiration date thereof is preferably written into the medium expiration date 714 of the storage unit 112 in shipment.

Although not illustrated, a disc ID for identifying the optical disc 113 may be stored in addition to the above-described information.

Here, the expiration date of the optical disc 113 may be written according to the following methods, that is, (1) a method in which the expiration date of the housed optical disc 113 is written to the storage unit 112 in shipment of the recording medium housing unit 111 housing the optical disc 113, (2) a method in which the expiration date is written into a management region (for example, a part of meta data) of the optical disc 113, and such information is acquired at any timing (for example, a timing at which the optical disc is mounted in the recording medium housing unit 111) and is written to the storage unit 112, and (3) a method in which expiration date information is acquired from a web server or the like by using information specific to each optical disc such as a manufacturing number recorded on the optical disc 113 and is written to the storage unit 112.

The configuration management unit 210 of the server 100 of the data library system 10 or the state management/display unit 116 of the portable recording apparatus 103 may hold the recording medium housing table 700.

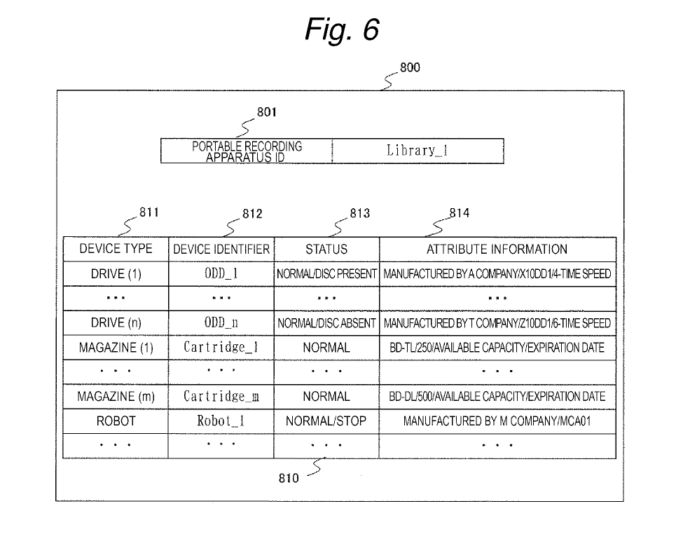

Next, with reference to FIG. 6, a description will be made of a configuration example of a portable recording apparatus configuration management table 800 managed by the state management/display unit 116 of the portable recording apparatus 103 of the data library system 10. The portable recording apparatus configuration management table 800 contains a portable recording apparatus ID 801 and configuration information 810. The portable recording apparatus ID 801 is an identifier for uniquely identifying the portable recording apparatus 103. The identifier does not overlap identifiers of other portable recording apparatuses 103 of the data library system.

The configuration information 810 is information regarding each device constituting the portable recording apparatus 103, and is formed of a device type 811, a device identifier 812, a status 813, and attribute information 814.

The device type 811 is information regarding the type of device included in the portable recording apparatus 103. For example, the device type 811 includes a drive indicating the data recording/reproducing unit 110, a magazine indicating the recording medium housing unit 111, and a robot indicating the recording medium transport unit 114.

The device identifier 812 is information for uniquely identifying a device included in the portable recording apparatus 103.

The status 813 indicates a working situation or a state of a device included in the portable recording apparatus 103.

The attribute information 814 is attribute information of a device included in the portable recording apparatus 103, for example, a manufacturer, a model name, and a specification.

A state of the portable recording apparatus 103 can be managed by using the portable recording apparatus configuration management table 800, and thus such information can be provided to the apparatus management server 50.

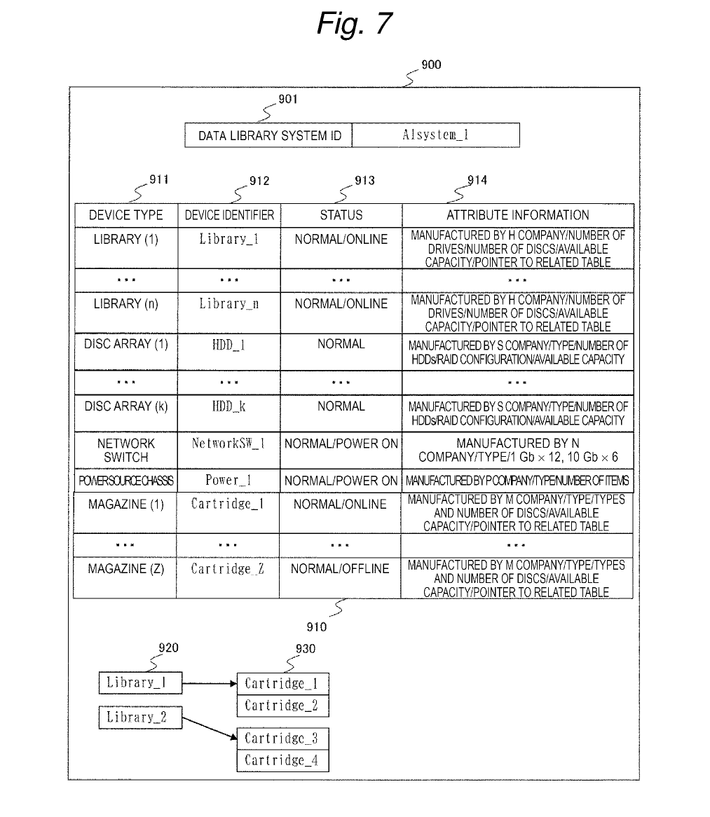

Next, with reference to FIG. 7, a description will be made of a configuration example of a system management table 900 managed by the configuration management unit 210 of the server 100 of the data library system 10.

The system management table 900 contains a data library system ID 901 and configuration information 910.

The data library system ID 901 is an identifier for uniquely identifying the data library system 10. The identifier does not overlap identifiers of other data library systems 10.

The configuration information 910 is information regarding each apparatus constituting the data library system 10, and is formed of a device type 911, a device identifier 912, a status 913, and attribute information 914.

The device type 911 is information regarding the type of apparatus included in the data library system 10. For example, the device type 911 includes a library indicating the portable recording apparatus 103, a disc array indicating the block storage 101, and a network switch (not illustrated) for connecting a power source chassis or each apparatus to the network.

The device identifier 912 is information for uniquely identifying an apparatus included in the data library system 10.

The status 913 indicates a working situation or a state of an apparatus included in the data library system 10.

The attribute information 914 is attribute information of an apparatus included in the data library system 10, for example, a manufacturer, a model name, a specification, and position information of a related table storing specific information or supplementary information.

The system management table 900 contains information (the reference numerals 920 and 930 in FIG. 7) indicating a relationship between the portable recording apparatus 103 and the recording medium housing unit 111. For example, it is possible to understand a correlation between the portable recording apparatus 103 and the recording medium housing unit 111 set therein, or the recording medium housing unit 111 which is not set in any portable recording apparatus 103.

Here, the information of the portable recording apparatus configuration management table 800 managed by the portable recording apparatus 103 may be acquired and may be incorporated into the system management table 900.

A state of the data library system 10 can be managed by using the system management table 900, and thus such information can be provided to the apparatus management server 50.

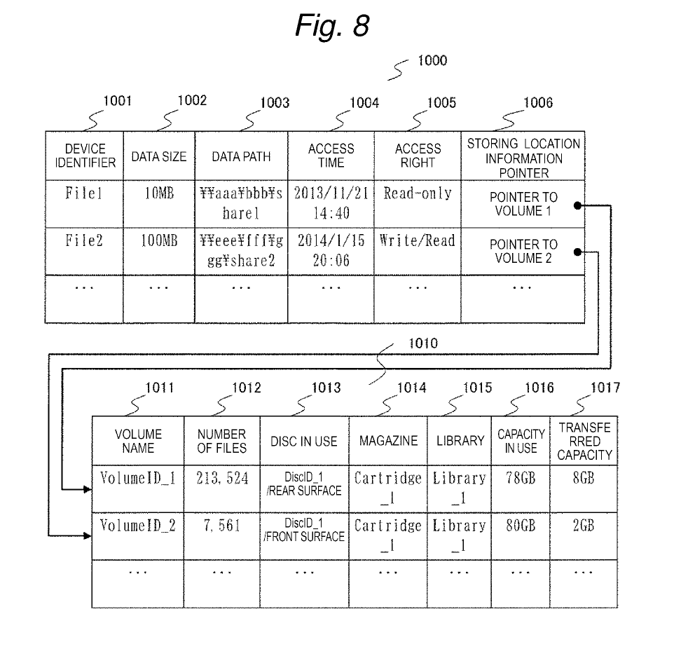

Next, with reference to FIG. 8, a description will be made of a configuration example of a data management table 1000 managed by the file management unit 207 of the server 100 of the data library system 10, the file management unit 311 of the application server 20, and the data management unit 513 of the apparatus management server 50.

The data management table 1000 contains a data identifier 1001, a data size 1002, a data path 1003, an access time 1004, an access right 1005, and a storing location information pointer 1006.

The data identifier 1001 indicates information for uniquely identifying data such as a management target file or object.

The data size 1002 indicates a size of management target data.

The data path 1003 indicates a data path in a storing region of a storage in which the management target data is stored.

The access time 1004 indicates time at which the management target data is accessed last.

The access right 1005 is an access right assigned to the management target data, for example, read only, and readable/writable.

The storing location information pointer 1006 is a pointer to a volume information table 1010, indicating position information (for example, the block storage 101 or the portable recording apparatus 103 of the data library system 10, the block storage 306 of the application server 20, or a block storage of the archive management server 40) of a storage in which an entity of a file or an object is stored.

The volume information table 1010 includes a volume name 1011, the number of files 1012, a disc in use 1013, a magazine 1014, a library 1015, capacity in use 1016, and transferred capacity 1017.

The volume name 1011 indicates information for uniquely identifying a space of data recorded on a single optical disc.

The number of files 1012 indicates a total number of files recorded on the optical disc corresponding to the volume name.

The disc in use 1013 indicates information for uniquely identifying the optical disc corresponding to the volume name, and a front surface and a rear surface if the optical disc has recording surfaces on both sides.

The magazine 1014 indicates information for identifying the recording medium housing unit 111 housing the disc in use.

The library 1015 indicates information for identifying the portable recording apparatus 103 in which the recording medium housing unit 111 indicated by the magazine 1014 is set.

The capacity in use 1016 indicates an amount of data recorded on the optical disc indicated by the disc in use 1013. Here, the amount of data indicates only a user data portion corresponding to a file or an object, or the entire data portion including system information.

The transferred capacity 1017 indicates a capacity of data which is copied to the block storage 101 or another optical disc since it is determined that data is required to be transferred as a result of quality inspection on the optical disc indicated by the disc in use 1013. For example, in a case where the capacity in use 1016 is 78 gigabytes (GB), and the transferred capacity 1017 is 8 GB, this indicates a state in which data of 8 GB of 78 GB has been copied to another storage. In a case where all data is copied to another storage, the storing location information pointer 1006 is changed.

It is possible to manage information regarding data such as a file, an object, a mail, or an image by using the data management table 1000.

Although not illustrated, there is also a form in which whether or not data retention information (the expiration date in which data is not erasable, or the like) is set, or whether or not encryption or compression is set is added to the data management table 1000.

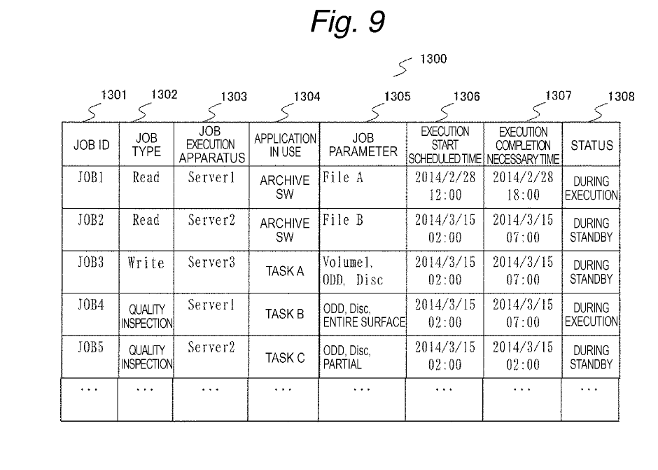

Next, with reference to FIG. 9, a description will be made of a configuration example of a job management table 1300 managed by the job execution management unit 512 of the apparatus management server 50.

The job management table 1300 includes a job ID 1301, a job type 1302, a job execution apparatus 1303, an application in use 1304, a job parameter 1305, an execution start scheduled time 1306, an execution completion necessary time 1307, and a status 1308.

The job ID 1301 indicates information for uniquely identifying a job.

The job type 1302 is information indicating the content of the job, and includes information such as “write” indicating that data is recorded from the block storage 101 into the portable recording apparatus 103, “read” indicating that the data recorded in the portable recording apparatus 103 is reproduced, and “quality inspection” indicating that quality inspection is performed on an optical disc housed in the portable recording apparatus 103.

The job execution apparatus 1303 is information indicating an apparatus which executes each job, and is, for example, an ID, a nickname, or an IP address.

The application in use 1304 is information regarding a location of an application or script on an apparatus, executed by each job, or information regarding a task.

The job parameter 1305 is parameter information required to execute each job. For example, in a case of “read”, the job parameter 1305 is a file name or a file path name read from the portable recording apparatus 103.

The execution start scheduled time 1306 is information indicating time at which a job is scheduled to be executed.

The execution completion necessary time 1307 is information indicating time at which execution of a job is completed. The execution completion necessary time 1307 may be blank if a manager or a user does not set time.

The status 1308 is information indicating a job execution state, and includes, for example, during standby, during execution, execution completed, and execution completed (failed).

By using the job management table 1300, the apparatus management server 50 can set execution jobs executed in the apparatus, such as hierarchizing of data, reading of archive data, and quality inspection on data, and can schedule the execution jobs in order to sequentially execute the jobs.

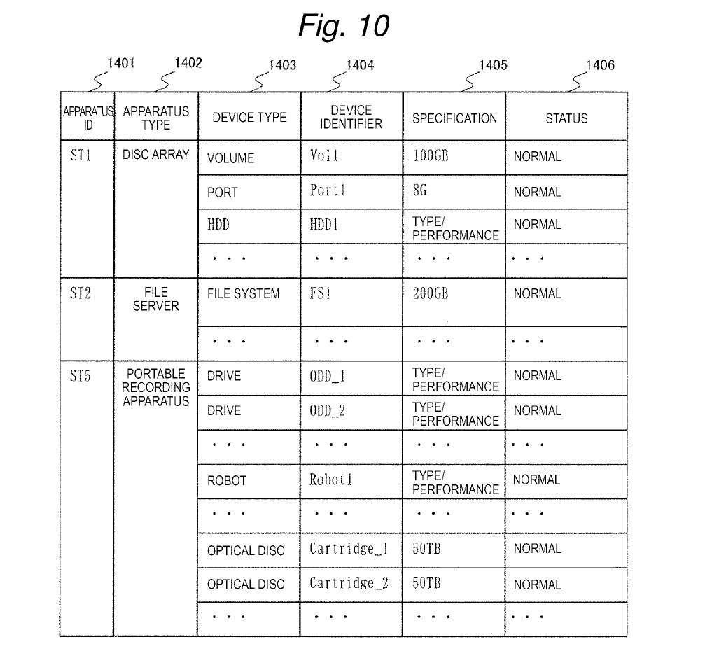

Next, with reference to FIG. 10, a description will be made of a configuration example of an apparatus configuration management table 1400 managed by the configuration management unit 510 of the apparatus management server 50. The table is generated by using the portable recording apparatus configuration management table 800 managed by the state management/display unit 116 of the portable recording apparatus 103 of the data library system 10 and the system management table 900 managed by the configuration management unit 210 of the server 100. Such information is periodically collected by the storage management unit 509 and the configuration management unit 510 from each management target apparatus.

The apparatus configuration management table 1400 includes an apparatus ID 1401, an apparatus type 1402, a device type 1403, a device identifier 1404, a specification 1405, and a status 1406.

The apparatus ID 1401 is information for uniquely identifying a management target apparatus.

The apparatus type 1402 is information indicating that the management target apparatus is any one of a disc array (block storage), a file server (application server), the server, and the portable recording apparatus.

The device type 1403 is information indicating the type of device included in each management target apparatus.

The device identifier 1404 is information for uniquely identifying a device included in each management target apparatus.

The specification 1405 has different set values depending on management targets. For example, in a case of a volume, a size is set; in a case of a port, a speed value is set; in a case of a file system, a size is set; in a case of a cache, a size is set; in a case of a driver, a read-write speed is set; in a case of a robot, a load time is set; and in a case of an optical disc, a size is set.

The status 1406 indicates a working situation or an operation state of each management target.

By the apparatus configuration management table 1400, the apparatus management server 50 can acquire information regarding each management target via the management network 12 and can collectively manage the information.

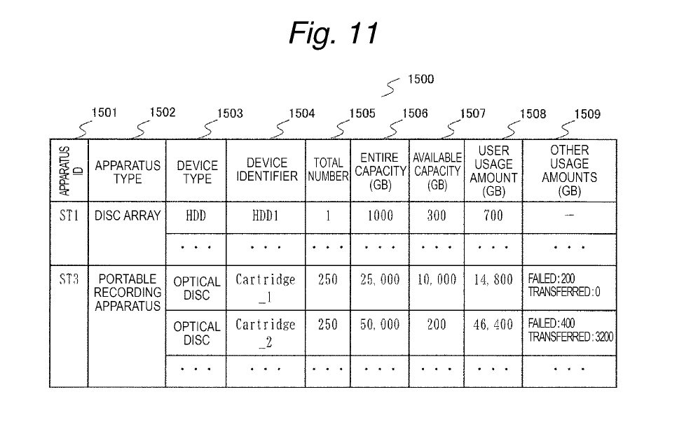

Next, with reference to FIG. 11, a description will be made of a capacity management table 1500 managed by the capacity management unit 511 of the apparatus management server 50. The table is generated by using the portable recording apparatus configuration management table 800 managed by the state management/display unit 116 of the portable recording apparatus 103 of the data library system 10 and the system management table 900 managed by the configuration management unit 210 of the server 100. Such information is periodically collected by the capacity management unit 511 from each management target apparatus.

The capacity management table 1500 includes an apparatus ID 1501, an apparatus type 1502, a device type 1503, a device identifier 1504, a total number 1505, the entire capacity 1506, an available capacity 1507, a user usage amount 1508, and other usage amounts 1509.

The apparatus ID 1501 is information for uniquely identifying a management target apparatus.

The apparatus type 1502 is indicates a management target apparatus.

The device type 1503 indicates the type of device included in a management target apparatus. For example, the block storage 101 of the data library system 10 is an HDD, and the portable recording apparatus 103 is an optical disc.

The device identifier 1504 is information for uniquely identifying a device included in each management target apparatus.

The total number 1505 indicates the number of storages included in a management target apparatus. For example, in a case of an HDD, the total number 1505 indicates the number of HDDs, and, in a case of an optical disc, the total number 1505 indicates the number of optical discs housed in the recording medium housing unit.

The entire capacity 1506 indicates the entire capacity of a storage included in each apparatus. For example, the entire capacity 1506 indicates the entire capacity of a logic volume described in Volume of the storage.

The available capacity 1507 indicates an allowable capacity of the storage included in each apparatus.

The user usage amount 1508 indicates an amount of data recorded in the storage included in each apparatus. The amount of data may indicate an amount of only a user data portion corresponding to a file or an object.

The other usage amounts 1509 indicate amounts of data which is used separately from the user usage amount 1508. For example, in a case of an optical disc, the other usage amounts 1509 indicate a size of a region which becomes unnecessary due to a failure of data recording, or a size of a region which becomes unnecessary due to data being transferred to another storage as a result of quality inspection.

By the capacity management table 1500, the apparatus management server 50 can acquire information regarding a capacity of the storage of each management target via the management network 12 and can collectively manage the information.

Here, the server 100 of the data library system 10 may hold the capacity management table 1500.

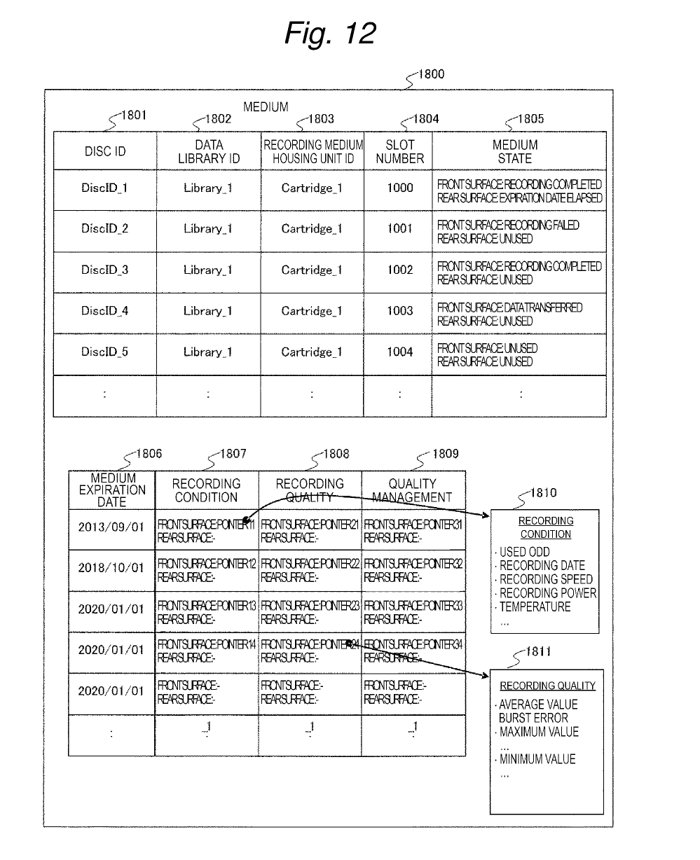

FIG. 12 illustrates an example of an optical disc management table 1800 managed by the configuration management unit 210 of the server 100.

The optical disc management table 1800 is a database table which records information such as a disc ID 1801, a data library ID 1802, a recording medium housing unit ID 1803, a slot number 1804, a medium state 1805, the medium expiration date 1806, a recording condition 1807, recording quality 1808, and quality management 1809, for each optical disc 113.

Information regarding the optical disc 113 housed in the recording medium housing unit 111 is registered or updated in the table 1800 in a case where the portable recording apparatus 103 attached with the recording medium housing unit 111 is connected to the server 100 of the data library system 10 of the present invention for the first time, in a case where a new recording medium housing unit 111 is set in the portable recording apparatus 103, or in a case where discs are exchanged due to periodic maintenance. The information regarding the optical disc 113 is updated when the optical disc 113 is moved between the data recording/reproducing unit 110 and the recording medium housing unit 111.

The disc ID 1801 is a character string or a number for identifying each optical disc 113. The ID is an ID for identifying an individual, recorded during manufacturing of the optical disc 113, without being changed, an ID generated on the basis of the ID, or an ID which is determined independently by the data library system 10 of the present invention. The disc in use 1013 of the data management table 1000 illustrated in FIG. 8, and disc information set in the job parameter 1305 of the job management table 1300 illustrated in FIG. 9 are the same value as the disc ID 1801.

The data library ID 1802 is an ID for identifying the portable recording apparatus 103. Information set in the portable recording apparatus ID 801 of the portable recording apparatus configuration management table 800 illustrated in FIG. 6, the device identifier 912 in a case where the device type 911 of the system management table 900 illustrated in FIG. 7 is a library, and the library 1015 of the data management table 1000 illustrated in FIG. 8 is the same value as the data library ID 1802.

The recording medium housing unit ID 1803 is a character string or a number for identifying the recording medium housing unit 111. The ID is determined and recorded in the storage unit 112 of the recording medium housing unit 111 before manufacturing of shipment of the recording medium housing unit 111. The ID is read from the storage unit 112 by the control unit 104 when registered or updated in the database table. As information which is set in the recording medium housing unit information 701 of the recording medium housing table 700 illustrated in FIG. 5, the device identifier 912 in a case where the device type 911 of the system management table 900 illustrated in FIG. 7 is a magazine, and the magazine 1014 of the data management table 1000 illustrated in FIG. 8, the recording medium housing unit ID 1803 is used.

The slot number 1804 is a value indicating a position of a slot housing the optical disc 113 indicated by the disc ID 1801 in the recording medium housing unit 111 indicated by the recording medium housing unit ID 1803. The ID is the same as information set in the slot number 711 of the recording medium housing table 700 illustrated in FIG. 5.

The medium state 1805 is a processing state, in which a state of the optical disc 113 indicated by the disc ID 1801 is recorded. The state 1805 includes states such as “unused”, “reserved”, “during recording”, “recording completed”, “recording failed”, “during quality inspection”, “quality inspection failed”, “during transfer”, “transferred”, “during reproduction”, “offline”, “unknown medium”, and “expiration date elapsed”. Here, in a case where the optical disc 113 has recording surfaces on both sides, a separate state is set for each surface.

The “unused” state indicates that the optical disc 113 indicated by the disc ID 1801 is not used, and thus data can be recorded thereon. The “reserved” state indicates that the optical disc 113 has already been fixed in terms of the usage and has been reserved. The “under recording” state indicates that data is actually being recorded on the optical disc 113 by the data recording/reproducing unit 110. The “recording completed” state indicates that the recording of data and a verification process have been normally completed. The “recording failed” state indicates that recording of data has failed during recording of the data on the optical disc 113 by the data recording/reproducing unit 110. The “during quality inspection” state indicates that quality inspection is being performed by the data recording/reproducing unit 110. The “quality inspection failed” state indicates that recording quality causes abnormal reproduction of data and thus inspection fails during quality inspection on the optical disc 113 performed by the data recording/reproducing unit 110. The “during transfer” state indicates that data recording quality is deteriorated as a result of the quality inspection and thus data is being copied to another location. The “transfer completed” state indicates that data on the optical disc 113 has been transferred to another location. The “during reproduction” state indicates that data on the optical disc 113 is being reproduced by the data recording/reproducing unit 110. The “offline” state indicates that the recording medium housing unit 111 housing the optical disc 113 is detached and is thus offline. The “unknown medium” state indicates that the data recording/reproducing unit 110 cannot perform recording or reproduction on the optical disc 113 housed in the slot. The “expiration date elapsed” state indicates that the expiration date has elapsed in a state in which the optical disc 113 housed in the slot is not used, and thus data cannot be recorded on the disc.

The medium expiration date 1806 is the expiration date on which the unused optical disc 113 can be used to record data, and is provided by a manufacturer of the optical disc.

The recording condition 1807 indicates a storing location of recording condition data 1810 in which a recording condition is written when data is recorded on the optical disc 113 indicated by the disc ID 1801.

The recording quality 1808 indicates a storing location of recording quality data 1811 in which recording quality right after data is recorded on the optical disc 113 indicated by the disc ID 1801 is written.

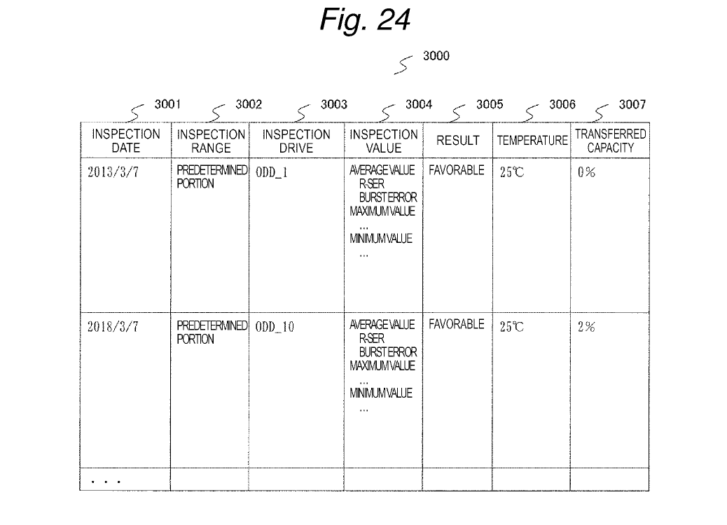

The quality management 1809 indicates a storing location of a quality inspection result log 3000 (FIG. 24 which will be described later) in which a result of quality inspection periodically performed on the optical disc 113 indicated by the disc ID 1801 is written.

Here, the recording condition data 1810 includes information such as information (a manufacturer name, a model type, a model number, and the like) regarding the data recording/reproducing unit 110 which records data on the optical disc 113, the data recording date, a recording speed or a recording laser power value (a value set by a recording setting unit 3315) in the data recording/reproducing unit 110, and the temperature for preserving the optical disc 113. In a case where data is recorded on a single recording medium by using a plurality of recording conditions, all recording conditions are written into the recording condition data 1810, or separate recording condition data 1810 is created, and the recording conditions are associated with each other.

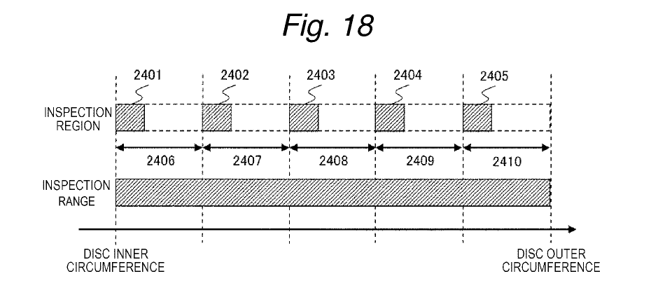

The recording quality data 1811 includes an average value, the maximum value, the minimum value, and the like of quality inspection values (random SER, the number of bytes in which burst errors occur, and the like) right after data is recorded. The quality inspection values may be written for each predetermined inspection region which will be described later in FIG. 18.

The quality inspection result log will be described later.

Next, with reference to the following drawings, a description will be made of a procedure in which the apparatus management server 50 and the data library system 10 periodically perform quality inspection related to recorded data on the optical disc 113 in the data library system 10.

Generally, it is known that quality deterioration of data recorded on the optical disc 113 is greatly influenced by the environmental temperature at which an optical disc is kept. Therefore, in the present example, the apparatus management server 50 periodically monitors the environmental temperature.

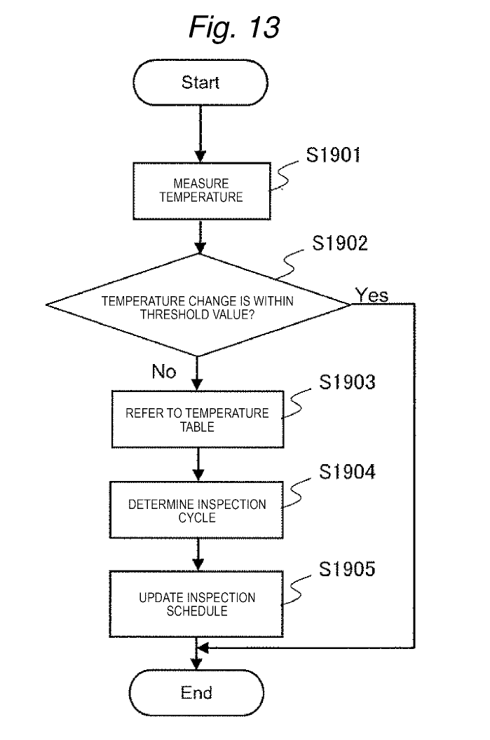

Detailed description thereof will be made with reference to FIG. 13.

First, the quality inspection information management unit 515 of the apparatus management server 50 extracts information regarding the portable recording apparatus 103 among apparatuses as management targets of the apparatus management server 50 by referring to the apparatus configuration management table 1400 managed by the configuration management unit 510. The quality inspection information management unit 515 instructs each portable recording apparatus 103 to measure the temperature. Specifically, the quality inspection information management unit 515 transmits a request (“temperature measurement request”) for causing a predetermined portable recording apparatus 103 to measure the temperature, to the server 100 connected to each portable recording apparatus 103 via the control unit 501 and the management I/F unit 506.

The control unit 201 of the server 100 which has received the temperature measurement request via the management I/F unit 212 instructs the library control unit 211 to cause the portable recording apparatus 103 to measure the temperature, and thus the library control unit 211 transmits the temperature measurement instruction to the portable recording apparatus 103 via the library I/F unit 203. The control unit 104 of the portable recording apparatus 103 which has received the temperature measurement instruction via the server I/F unit 107 measures the current environmental temperature by using the thermometer 117 and notifies the server 100 of a temperature measurement value via the server I/F unit 107. The control unit 201 of the server 100 which has received the current temperature measurement value notifies the management I/F unit 212 of the measurement value. The control unit 501 having received the temperature measurement value via the management I/F unit 506 notifies the quality inspection information management unit 515 thereof (step S1901).

The quality inspection information management unit 515 of the apparatus management server 50 having the current environmental temperature acquires an environmental temperature measurement value which is previously measured from the memory 502 and compares the measurement value acquired in step S1901 with the current environmental temperature measurement value (step S1902).

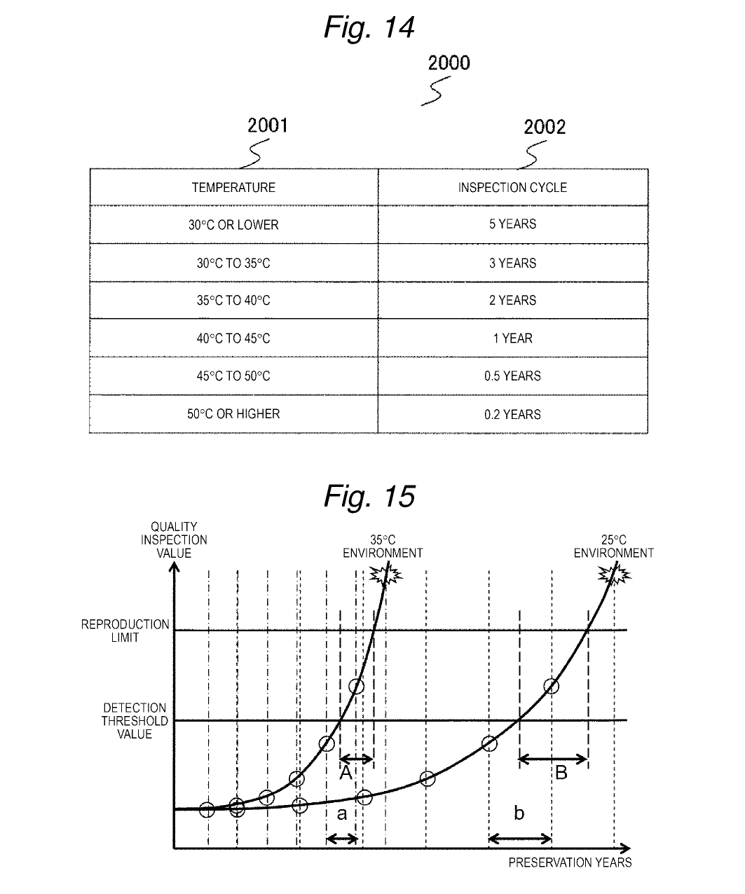

As a result of the comparison in step S1902, if a predetermined threshold value is exceeded, an inspection cycle table showing a relationship between the environmental temperature and the extent of deterioration progress of the optical disc 113 is referred to. FIG. 14 illustrates a configuration example of an inspection cycle table 2000 showing a relationship between the environmental temperature and an inspection cycle, and is held in the memory 502 or the block storage 505 of the apparatus management server 50, or the memory 202 or the block storage 101 of the server 100. The table may be held in the memory 105 of the portable recording apparatus 103 (step S1903).

Next, the current environmental temperature is collated with a temperature range written into the inspection cycle table 2000, and an appropriate inspection cycle (T2) is determined. The current quality inspection schedule is acquired from the quality inspection schedule generation unit 516, and an inspection cycle (T1) which is current set is confirmed. If T1>T2 or T1=T2, the inspection cycle is maintained to be T1, and if T1<T2, the inspection cycle is set to T2 (step S1904).

The quality inspection schedule generation unit 516 is instructed to update the quality inspection schedule (step S1905).

For example, in a case where the current environmental temperature acquired in step S1901 is 30° C., and the previously measured result is 28° C., the inspection cycle is five years on the basis of the previously measured result, but the inspection cycle is three years on the basis of the current environmental temperature. Therefore, the quality inspection schedule which is previously set is required to be changed.

If there is no great difference from the previous measurement value in step S1902, the quality inspection schedule is not required to be changed, and thus this process is finished.

Here, in step S1901, the quality inspection information management unit 515 of the apparatus management server 50 may directly give a temperature measurement instruction to each portable recording apparatus 103 via the management I/F unit 506 without using the server 100.

The control unit 201 or the quality inspection control unit 215 of the server 100 of the data library system 10 may periodically instruct the portable recording apparatus 103 to measure the temperature, may hold the acquired temperature in the memory 202 or the block storage 101, and may notify the apparatus management server 50 of the measured temperature as necessary.

The control unit 104 of the portable recording apparatus 103 may periodically measure the temperature by using the thermometer 117, may hold a measurement result in the memory 105, and may notify the server 100 or the apparatus management server 50 of the measurement result as necessary. The temperature measurement value is collated with the previous measurement value and the inspection cycle table 2000, and it is monitored that the current measurement value is greater or is not changed. For example, in a case where the previous measurement value is 25° C., and the current measurement value is 30° C., looking at the inspection cycle table 2000, the inspection cycle is changed, and thus the temperature may be caused to be equal to or lower than 30° C. by using the fan 118 in order to prevent the inspection cycle from being changed. Alternatively, the temperature of a location where the system of the present example is installed may be set to a threshold value (for example, 35° C.) in advance, and the fan 118 may be controlled if the temperature exceeds the threshold value.

As mentioned above, it is possible to appropriately manage the environmental temperature which greatly influences quality deterioration of an optical disc and also to select an inspection cycle which is appropriate for a preservation environment. Thus, unnecessary quality inspection can be prevented from being performed.

Next, a description will be made of an actual quality inspection method.

First, a description will be made of a life prediction method used to analyze an acquired inspection value as a result of quality inspection.

FIG. 15 is a diagram illustrating prediction of the life of an optical disc estimated by using the Arrhenius model. The Arrhenius model is a chemical reaction model in which a temperature is used as active energy, and a failure of an evaluated material is predicted on the basis of a change in the environmental temperature. FIG. 15 illustrates changes in quality inspection values under a high temperature (35° C.) environment and changes in quality inspection values under a low temperature (25° C.) environment. Under the high temperature environment, the active energy is higher and a chemical reaction progresses faster than under the low temperature environment, and thus the extent of progress of deterioration of an optical disc is higher. In terms of long-period preservation, it is predicted that an optical disc which is preserved under the environment of 35° C. causes reproduction errors earlier than an optical disc which is preserved under the environment of 25° C. For this reason, an inspection cycle b of each optical disc 113 under the environment of 25° C. is made shorter than a period B after a detection threshold value in which rewriting of the optical disc 113 using the portable recording apparatus 103 is recommended is reached until reproduction errors actually occur. Therefore, appropriate rewriting can be performed through quality inspection, and thus reliability of the portable recording apparatus 103 can be ensured. This is also the same for the environment of 35° C. In other words, each optical disc is inspected at an inspection cycle a which is shorter than a period A after a detection threshold value in which rewriting of the optical disc 113 is recommended is reached until reproduction errors actually occur. According to this method, the portable recording apparatus 103 can perform appropriate rewriting without causing reproduction errors. Here, the quality is indicated by an error rate or the number of errors calculated through error correction, but may employ a waveform symmetry index β of a reproduction signal, a modulation degree M of the signal amplitude, or a jitter which is a fluctuation component of a binary signal on the time axis, which indirectly shows the tendency of errors.

In the present example, relational values regarding preservation years, a quality inspection value, a detection threshold value, and a reproduction limit corresponding to each temperature range illustrated in FIG. 15 are held in the memory 202 or the block storage 101 of the server 100 as a life prediction table. The same table may be held in the apparatus management server 50 or the portable recording apparatus 103. The life prediction table is used to analyze a quality inspection value which will be described later.

Next, a description will be made of a range of targets on which quality inspection is performed.

In a case where quality of data recorded on an optical disc is inspected, if all data is inspected, inspection time increases, and thus there is a possibility that other processes, that is, an archive process or a restoring process may be influenced. For example, in a case where a size of a single disc is 100 GB, and reading performance of the data recording/reproducing unit 110 is 18 MB/second, about 90 minutes is required to inspect all data, and the data recording/reproducing unit 110 is used during that time. For this reason, if the restoring process is to be performed, there is a possibility that the data recording/reproducing unit 110 may not be used.

Therefore, a description will now be made of a quality inspection target region in which a quality deterioration pattern of a disc is taken into consideration.

A detection result in a quality index differs depending on deterioration factors of the optical disc 113. Therefore, deterioration factors of the optical disc 113 are compared with each other.

The deterioration factors of the optical disc 113 are roughly classified into (1) a change over time which is deterioration in the optical disc, (2) damage depending on an operation system, and (3) dust depending on a preservation environment. As a result, all the factors are detected as deterioration in reproduction quality, but it is possible to increase use efficiency of an optical disc by sorting the factors according to the extent of influence thereof or a range of influence thereof.

Regarding the influence of the dust, the dust is predicted to relatively uniformly influence, especially, an optical disc surface among the factors. Regarding the deterioration over time, a quality change tends to be detected from an outer circumferential side which is an end surface of the optical disc. The damage depends on a transport mechanism (recording medium transport unit 114) of the portable recording apparatus 103, and there is a high possibility that the damage may occur mainly on the outer circumferential side of the optical disc. This is because a contact point between the optical disc 113 and the transport mechanism or the recording medium housing unit 111 is located at the outer circumference of the optical disc. Particularly, the outer circumference of the optical disc has only a margin of about 2 mm relative to a diameter of 12 cm, and thus there is a high possibility that quality deterioration may occur due to the transport mechanism. Continuous damage caused by the transport mechanism, especially, damage over a wide range may be determined as being burst errors which are consecutive defects.

As mentioned above, in determination of deterioration, it is predicted that discrete burst errors, over the entire optical disc are caused by dust, and burst errors biased toward the outer circumference of the disc are caused by deterioration over time or damage.

FIG. 17 is a diagram illustrating inspection regions in the optical disc 113, for inspecting dust. An inspection region A is a region from an inner circumference of the optical disc to a central circumference and is expected to be substantially uniformly influenced by dust or the like. In contrast, an inspection region B is an outer circumference (for example, a range from 55 mm to 58 mm) of the optical disc. In this region, a unique factor is hard to specify due to a factor such as damage caused by the transport mechanism and an influence of deterioration over time of recording quality being included in addition to the influence of dust.

Therefore, the quality inspection execution unit 119 performs inspection by restricting an inspection range to the inspection region A. It is possible to achieve an effect of reducing inspection time by restricting a range of the inspection region A.

FIG. 18 is a diagram illustrating a relationship between an inspection region and an evaluation region in an optical disc surface.

An optical disc mounted in the data library system 10 is assumed to be a large capacity disc and to have a plurality of recording layers.

Generally, dominant factors which influence the life (reliability) of the optical disc are recording layers, laminate materials and structures of the vicinity thereof, and the above-described preservation environment. The preservation environment is an environment in which the optical disc is preserved, and the extent of influence of quality deterioration of the optical disc changes depending on the above-described environmental temperature or humidity. The factors tend to be exhibited as a whole, and can be predicted to some degree on the basis of a result of evaluating a part of the optical disc. On the other hand, a recording state of the optical disc depends on an individual difference or a drive or an adjustment result, and the same tendency is not necessarily expected between the recording layers. For this reason, the recording layer unit is set as a single inspection range. As a location where a representative value is acquired, for example, a leading portion of each inspection range is used as an actual inspection target (inspection region). Since reliability of accuracy of the inspection is required, evaluation is performed on the basis of a plurality of acquisition results by using an error correction code (ECC) block which is the unit of data modulation as a reference, and thus acquisition variations can be reduced, thereby allowing stable quality inspection to be performed.

In FIG. 18, leading portions 2401, 2402, 2403, 2404 and 2405 of the respective inspection ranges are defined as evaluation regions (inspection regions), evaluation is performed by restricting a representative value in each inspection range to a value in an evaluation region in the inspection range, and thus inspection time can be decreased without reducing inspection accuracy. In FIG. 18, for simplification, the inspection range and the evaluation region have the same size, but may have different sizes. In FIG. 18, the number of inspection ranges is five, but may be any number with the ECC block as a reference. The number of inspection ranges may be changed depending on the recording layers. A plurality of patterns of inspection regions may be used. For example, in a case where an elapsed period from recording of data is short, the number of inspection regions may be five, and as an elapsed period is lengthened, the number or sizes of inspection regions may be increased.

As described above, an inspection region is restricted to the region as illustrated in FIGS. 17 and 18, but the above-described conditions may be combined with each other.

For example, the inspection range illustrated in FIG. 18 may be set as the inspection region A illustrated in FIG. 17, and the inspection regions 2401 to 2405 may be determined within the range of the inspection region A. In the present example, hereinafter, a description will be made assuming that quality inspection is performed on only such a region.

Next, a description will be made of a procedure of creating a quality inspection schedule.

In the present example, schedule management of periodic quality inspection is performed by the quality inspection information management unit 515 and the quality inspection schedule generation unit 516 of the apparatus management server 50.

As described above, the quality inspection information management unit 515 of the apparatus management server 50 determines an inspection cycle by using the temperature written into the recording condition of the optical disc management table 1800 when data is recorded on the optical disc 113 in the data library system 10, and instructs the quality inspection schedule generation unit 516 to generate the next quality inspection execution schedule for the optical disc 113.

The quality inspection schedule generation unit 516 generates the next quality inspection execution schedule on the basis of an inspection cycle (Ta) for which an instruction is given by the quality inspection information management unit 515 by referring to the recording date (T1) written into the recording condition of the optical disc management table 1800 regarding the designated optical disc 113 or the previous quality inspection date (T2) (a quality inspection information table illustrated in FIG. 24 to be described later) written into the quality inspection history which is held in the memory 502 or the block storage 505.

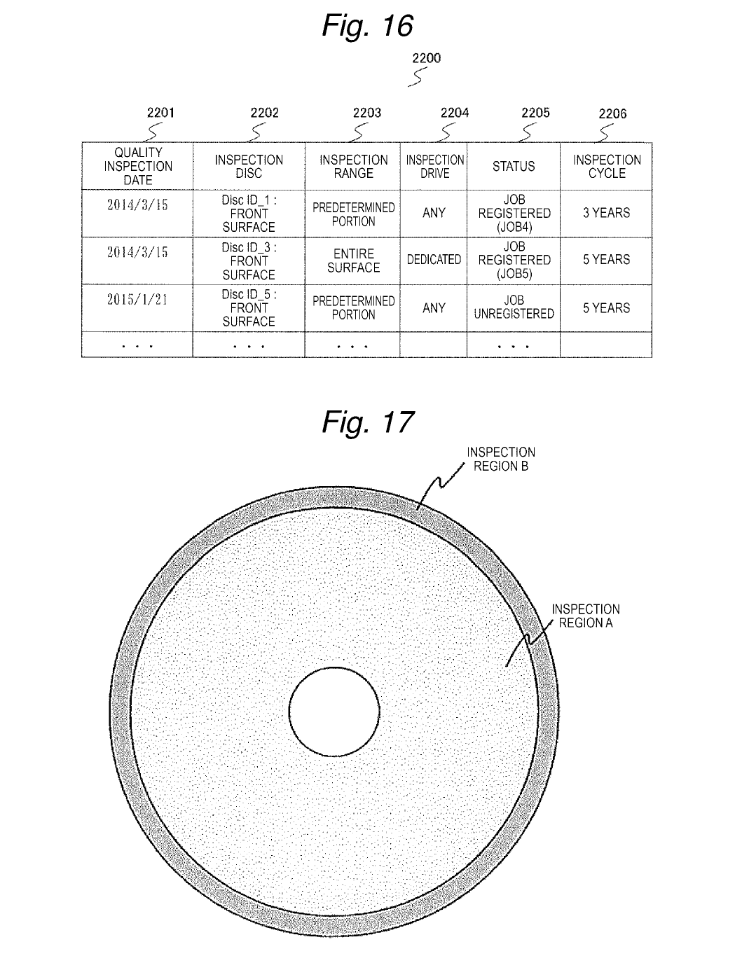

FIG. 16 illustrates an example of a quality inspection schedule table 2200 generated by the quality inspection schedule generation unit 516.

The quality inspection schedule table 2200 includes the quality inspection date 2201, an inspection disc 2202, an inspection range 2203, an inspection drive 2204, a status 2205, and an inspection cycle 2206.

The quality inspection date 2201 indicates the next inspection date (T). For example, the inspection date is set to T=T1+Ta or T=T2+Ta. If allowable, the inspection date may be set to one month before T. The medium state 1805 of the optical disc management table 1800 is referred to, and, if there is an optical disc whose expiration date comes soon, the inspection date may be set to the expiration date.

The inspection disc 2202 indicates an identifier of an optical disc for which an instruction is given by the quality inspection information management unit 515. In a case where the optical disc has recording surfaces on both sides, a front surface or a rear surface is written into the inspection disc 2202.

The inspection range 2203 indicates an inspection region on which quality inspection is performed in the optical disc. In a case where all data on the optical disc is inspected, the entire surface is written, and in a case where only a predetermined portion is inspected, a predetermined portion is written. For example, in a case where the entire inspection region A illustrated in FIG. 17 is inspected, the entire surface is written, and the inspection region A illustrated in FIG. 17 is partially inspected, a predetermined portion is written.

The inspection drive 2204 indicates the data recording/reproducing unit 110 of the portable recording apparatus 103 used for quality inspection on the optical disc. In a case where any data recording/reproducing unit 110 of the portable recording apparatus 103 may be used, any data recording/reproducing unit 110 is used, and in a case where the data recording/reproducing unit 110 used for quality inspection only is mounted in the portable recording apparatus 103, the dedicated data recording/reproducing unit 110 is used. The data recording/reproducing unit 110 used for quality inspection only indicates that the data recording/reproducing unit 110 is formally authorized as one for quality inspection.

The status 2205 indicates a situation in which the schedule is executed. In a case where the quality inspection schedule generation unit 516 generates the schedule, “job unregistered” is written, and in a case where the quality inspection schedule generation unit 516 or the quality inspection information management unit 515 registers the schedule in the job management table 1300 of the job execution management unit 512, “job registered (job number)” is written.

The inspection cycle 2206 indicates an quality inspection cycle which is currently set in the inspection disc 2202. The above-described content set in step S1904 of FIG. 13 described above is written.

The quality inspection schedule generation unit 516 monitors the generated quality inspection schedule table 2200, and requests the job execution management unit 512 to register the schedule if the quality inspection schedule is a predetermined period before the execution date (for example, one week before the execution date, or one month before the execution date).

The job execution management unit 512 checks the content of the job management table 1300 and determines whether or not the content which is requested to be registered can be executed as scheduled. In a case where the content can be executed as scheduled, the schedule which is requested to be registered is set in the job management table 1300, and the quality inspection schedule generation unit 516 is notified of the job ID 1301.

On the other hand, in a case where it is determined that the job execution management unit 512 cannot execute the condition as scheduled, the quality inspection schedule generation unit 516 is notified of information indicating that the content cannot be executed. The quality inspection schedule generation unit 516 outputs the information indicating that quality inspection cannot be performed as scheduled, to the display device 102 via the external display control unit 508 so as to notify a user or a manage thereof.

Next, a description will be made of a procedure of executing a quality inspection job registered in the job management table 1300.

The job execution management unit 512 of the apparatus management server 50 sequentially executes the jobs registered in the job management table 1300.

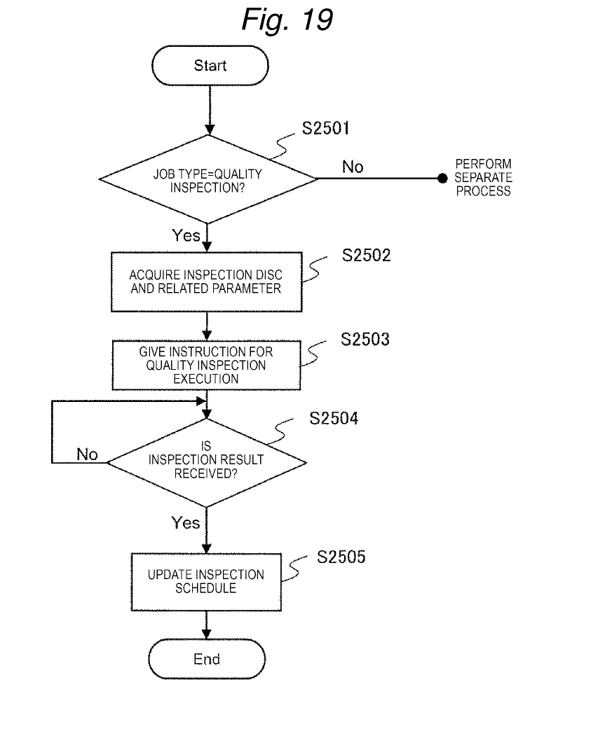

FIG. 19 illustrates a process flow in a case where an executed job is “quality inspection”.

It is determined whether or not a job is “quality inspection” by referring to the job type 1302 of the job management table 1300. If the job is not “quality inspection”, the job execution management unit 512 performs a separate process (step S2501).

In a case of the “quality inspection”, the job execution management unit 512 reads the job execution apparatus 1303 and the job parameter 1305 from the job management table 1300 (step S2502), and transmits a quality inspection execution request and the job parameter 1305 to the server 100 indicated by the job execution apparatus 1303 via the management I/F unit 506 (step S2503).

Thereafter, the job execution management unit 512 updates the status of the job management table 1300 from “during standby” to “during execution”, and waits for a quality inspection execution result to be received from the server 100 (step S2504).

If the quality inspection execution result is received from the server 100 in step S2504, the job execution management unit 512 notifies the quality inspection information management unit 515 of the result, and updates the status of the job management table 1300 from “during standby” to “execution completed” or “execution completed (failed)”.

The quality inspection information management unit 515 checks the quality inspection execution result. If the quality inspection has failed, the quality inspection information management unit 515 outputs information indicating that the quality inspection has failed to the display device 102 via the external display control unit 508 so as to notify the user or the manager of the information.

On the other hand, in a case where the quality inspection execution is successful, the quality inspection information management unit 515 checks the detailed content (the content of the quality inspection result log 3000 illustrated in FIG. 24) included in the quality inspection execution result. If the result is favorable, the quality inspection information management unit 515 refers to the inspection cycle table 2000 illustrated in FIG. 14 and the life prediction table illustrated in FIG. 15 so as to determine the next inspection cycle, inspection range, and a drive used for inspection, and requests the quality inspection schedule generation unit 516 to update the next quality inspection schedule. For example, even if the result is “favorable” and thus the inspection cycle table 2000 shows “five years” as an inspection cycle, in a case where a period to reach a detection threshold value at the corresponding environmental temperature in the life prediction table is short, the period is used as an inspection cycle.

The quality inspection schedule generation unit 516 updates the quality inspection date 2201, the inspection range 2203, and the inspection drive 2204 of the quality inspection schedule table 2200, and sets the status 2205 to “job unregistered” (step S2505).

Here, the job execution management unit 512 may notify the quality inspection information management unit 515 of the information read in step S2502, and the quality inspection information management unit 515 may make the quality inspection execution request in step S2503.

The quality inspection information management unit 515 may hold the quality inspection execution result received in step S2505 in the memory 502 or the block storage 505.

Next, a description will be made of a quality inspection process in the server 100 which receives the quality inspection execution request and the parameter from the apparatus management server 50 via the management I/F unit 212 in the above step S2503.

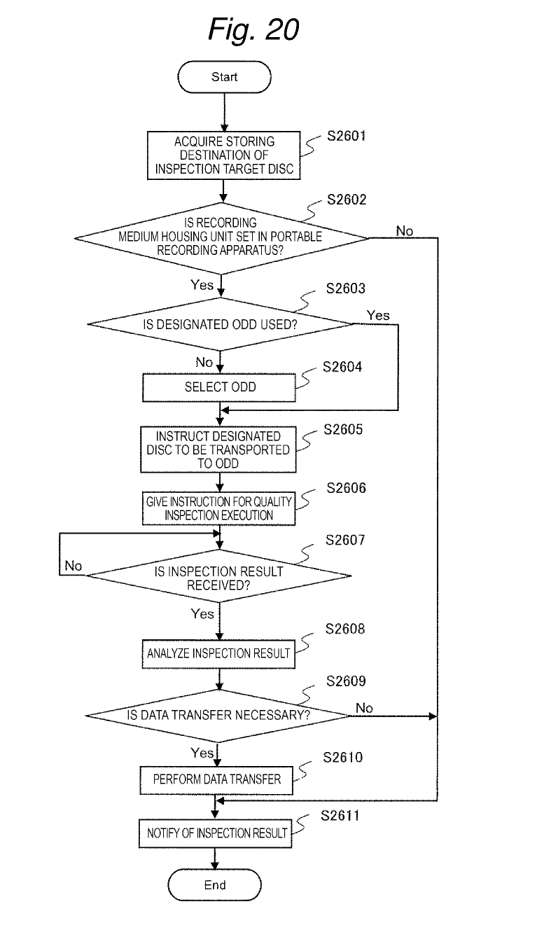

FIG. 20 illustrates a flow of the quality inspection process performed by the server 100.

The control unit 201 of the server 100 which has received the quality inspection execution request from the apparatus management server 50 via the management I/F unit 212 notifies the quality inspection control unit 215 of the parameter which is received along with the quality inspection execution request.

The quality inspection control unit 215 refers to the received parameter and acquires information regarding the recording medium housing unit 111 housing the inspection target optical disc. The information may be included in the parameter, and may be acquired from the system management table 900 held in the configuration management unit 210 (step S2601).

Successively, the quality inspection control unit 215 determines whether or not there is the portable recording apparatus 103 in which the recording medium housing unit 111 indicated by the information acquired in step S2601 is set by referring to the system management table 900 (step S2602).

If there is the portable recording apparatus 103 in which the recording medium housing unit 111 is set in step S2602, it is determined whether or not the data recording/reproducing unit 110 which will perform quality inspection is designated by referring to the parameter (step S2603).

If the data recording/reproducing unit 110 is not designated in step S2603, the data recording/reproducing unit 110 to be used for the quality inspection is designated. A selection method may be the same as a method of selecting the data recording/reproducing unit 110 during recording of data (step S2604).

Next, the quality inspection control unit 215 requests the library control unit 211 via the control unit 201 to set the quality inspection target optical disc in the data recording/reproducing unit 110 selected in step S2604 or the data recording/reproducing unit 110 designated in step S2603. The library control unit 211 gives an instruction therefor to the portable recording apparatus 103 via the library I/F unit 203 (step S2605).

Thereafter, the quality inspection control unit 215 requests the library control unit 211 via the control unit 201 to perform quality inspection on the quality inspection target optical disc according to a method indicated by the parameter received in step S2601. The library control unit 211 gives an instruction therefor to the portable recording apparatus 103 via the library I/F unit 203 (step S2606).

The quality inspection control unit 215 waits for a quality inspection execution result to be received from the portable recording apparatus 103 (step S2607).

If the quality inspection result is received from the library control unit 211, the quality inspection control unit 215 notifies the quality result analysis unit 216 of the result so as to make a request for analyzing quality deterioration (step S2608).

It is determined whether or not data transfer is necessary on the basis of an analysis result from the quality result analysis unit 216, and the process proceeds to step S2611 if the data transfer is not necessary (step S2609).

If the quality result analysis unit 216 determines that the data transfer is necessary in step S2609, the quality inspection control unit 215 instructs the data transfer control unit 217 to transfer data. The data transfer control unit 217 copies all data recorded on the quality inspection target optical disc or only a portion required to be transferred, to another new optical disc or the block storage 101 (step S2610).

Thereafter, the quality inspection control unit 215 notifies the apparatus management server 50 of the quality inspection execution result via the control unit 201. Here, if there is no portable recording apparatus 103 in which the recording medium housing unit 111 is set in step S2602, the recording medium housing unit 111 is in an offline state, and thus the apparatus management server 50 is notified of information indicating that the quality inspection execution has failed, and the recording medium housing unit 111 is in an offline state (step S2611).

Next, a description will be made of an analysis flow in which the quality result analysis unit 216 of the server 100 specifies a deterioration factor by using the quality inspection execution result in the above step S2608.

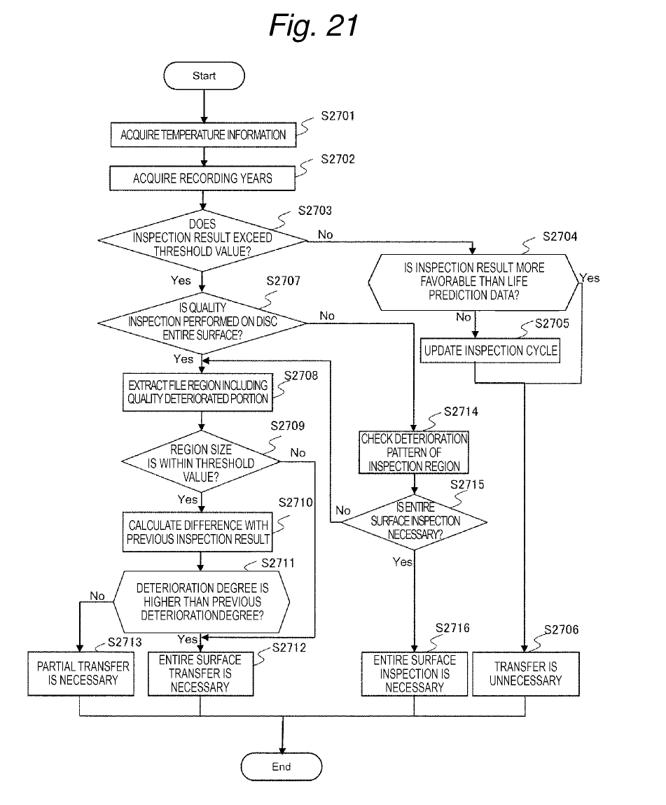

FIG. 21 illustrates a flow of an analysis process performed by the quality result analysis unit 216 of the server 100.

The quality result analysis unit 216 which has acquired the quality inspection execution result from the quality inspection control unit 215 instructs to the portable recording apparatus 103 which is a quality inspection target to measure the environmental temperature via the library control unit 211, and acquires the current environmental temperature information. In addition and/or alternatively, the quality inspection history indicated by the quality management 1809 of the optical disc management table 1800 of the server 100 is acquired, and a change rate of the environmental temperature relative to the previous quality inspection is checked. In a case where the history of the environmental temperature which is periodically measured is held in the memory 202 or the block storage 101, the environmental temperature may be used (step S2701).

The recording date written into the recording condition data 1810 of the optical disc management table 1800 is acquired, and elapsed years from the date on which data is recorded on the optical disc 113 is checked (step S2702).

Steps S2701 and S2702 may be reversed in an order thereof.

Next, it is determined whether or not a result of execution of the current quality inspection exceeds a threshold value which causes data to be transferred, that is, a deterioration detection threshold value (the detection threshold value in FIG. 15) (step S2703).

If the result does not exceed the detection threshold value in step S2703, the environmental temperature (for example, 25° C.) in step S2701, the elapsed years (for example, five years) in step S2702, and the inspection result (K1) are collated with the content of the life prediction table illustrated in FIG. 15. An environmental temperature index (for example, the curve corresponding to the environment of 25° C. in FIG. 15) is selected in the life prediction table, and a quality inspection value (Kt) at the elapsed years (five years) is acquired. The current inspection result (K1) is compared with the quality inspection value (Kt) (step S2704).

If K1<Kt or K1=Kt as a result of the comparison in step S2704, it is determined that a deterioration change substantially occurs according to the environmental temperature index (“favorable”), and the quality inspection control unit 215 notifies of an analysis result that the data on the optical disc is not required to be rewritten (“transfer unnecessary”) (step S2706).

If K1>Kt as a result of the comparison in step S2704, it is determined that deterioration occurs faster than in the environmental temperature index (“standard or less”), and the quality inspection control unit 215 is notified of the analysis result and is instructed to set the next inspection cycle to be short (step S2705).

On the other hand, if the current quality inspection result exceeds the detection threshold value in step S2703, it is checked whether the current quality inspection is performed on the entire surface of the optical disc 113 or only a predetermined portion (step S2707).

If the current quality inspection is performed on the entire surface of the optical disc 113 in step S2707, a file region and a size thereof corresponding to a location where quality deterioration is recognized are extracted. Here, the extracted region may include not only the entity of an archived file but also attached information related to files of redundant codes, meta data, or the like (step S2708).

It is determined whether or not the size of the file region which is extracted in step S2708 and is required for data to be transferred is within a predetermined threshold value (for example, 10% of the capacity of a single optical disc) (step S2709).

If the size of the file region exceeds the threshold value in step S2709, it is determined that all the data on the optical disc is required to be transferred to another storage (“entire surface transfer”), and the quality inspection control unit 215 is notified of the analysis result (step S2712).

If the size of the file region is within the threshold value in step S2709, the previous quality inspection value (Kp) is acquired from the quality inspection history indicated b the quality management 1809 of the optical disc management table 1800. A difference (deterioration degree R) between the previous quality inspection value (Kp) and the current quality inspection value (K1) is calculated (step S2710).

An environmental temperature index is selected in the life prediction table illustrated in FIG. 15 in the same manner as in step S2704, a quality inspection value (Kt1) for the preservation years in the previous inspection and a quality inspection value (Kt2) for the preservation years in the current inspection are acquired, and an expected deterioration degree (Rt) is calculated. The actual deterioration degree R calculated in step S2710 is compared with the expected deterioration degree Rt (step S2711).

As a result of comparison between the deterioration degrees in step S2711, if R>Rt×α (where α is a coefficient), this shows that deterioration over time considerably progresses. Therefore, it is determined that all the data on the optical disc is required to be transferred (“entire surface transfer”), and the quality inspection control unit 215 is notified of the analysis result. Here, α may be set by referring to a slope around the detection threshold value on the curve indicated by the environmental temperature index of the life prediction table (step S2712).

As a result of comparison between the deterioration degrees in step S2711, if R<Rt×α, it is determined that deterioration occurs due to dust or damage instead of the deterioration over time, and it is also determined that data of only the portion extracted in step S2708 is required to be transferred (“partial transfer”). The quality inspection control unit 215 is notified of the analysis result. Here, in addition to the level of the deterioration degree, whether or not the current elapsed years is close to preservation years which is scheduled to reach the detection threshold value may be added as a condition. For example, if R<Rt×α but the elapsed years=the preservation years−3, the entire transfer is determined (step S2713).

Next, in a case where the current quality inspection is performed on only a predetermined portion of the optical disc 113 in step S2707, a deterioration pattern of the inspection region is analyzed (step S2714).

As a result of analyzing the deterioration pattern in step S2714, it is determined again whether or not quality inspection is required to be performed on the entire surface of the optical disc 113. If the entire surface inspection is not necessary, the process proceeds to step S2708, and if the entire surface inspection is necessary, the process proceeds to step S2716 (step S2715).

For example, in a case where only one (for example, the inspection region 2404) of the inspection regions 2401 to 2405 illustrated in FIG. 18 exhibits a value exceeding the threshold value or continuous portions (for example, the inspection regions 2403 and 2404) exhibit values exceeding the threshold value, it is determined that deterioration locally occurs due to dust or damage, and the entire surface inspection is not necessary. For caution's sake, quality inspection may be performed on the region 2409 including the region 2404 and the region 2408 including the region 2403.

In a case where portions separate from each other exhibit values exceeding the threshold value, such as the regions 2401 and 2405 among the inspection regions, or an outer circumferential portion of the region 2404 or 2405, or the like exhibits a value exceeding the threshold value, there is a possibility that deterioration over time may progress over the disc entire surface, and thus the entire surface inspection is necessary.

In a case where, among the inspection regions, the number of deterioration regions exhibiting values exceeding the threshold value is larger than a predetermined number (for example, three), the entire surface inspection is performed on new inspection regions including regions other than the inspection regions.

If it is determined that the entire surface inspection is necessary in step S2715, the quality inspection control unit 215 is notified of the analysis result (step S2716).

As mentioned above, the quality result analysis unit 216 of the server 100 can appropriately determine entire surface transfer or partial transfer of recorded data on the basis of a deterioration state of an inspection target optical disc, and thus to prevent unnecessary data transfer. In addition, partial data transfer can be performed, and thus it is possible to reduce data transfer time.

Next, a description will be made of a data transfer flow in which the data transfer control unit 217 of the server 100 transfers data of a quality deteriorated portion on the optical disc in the above step S2610.

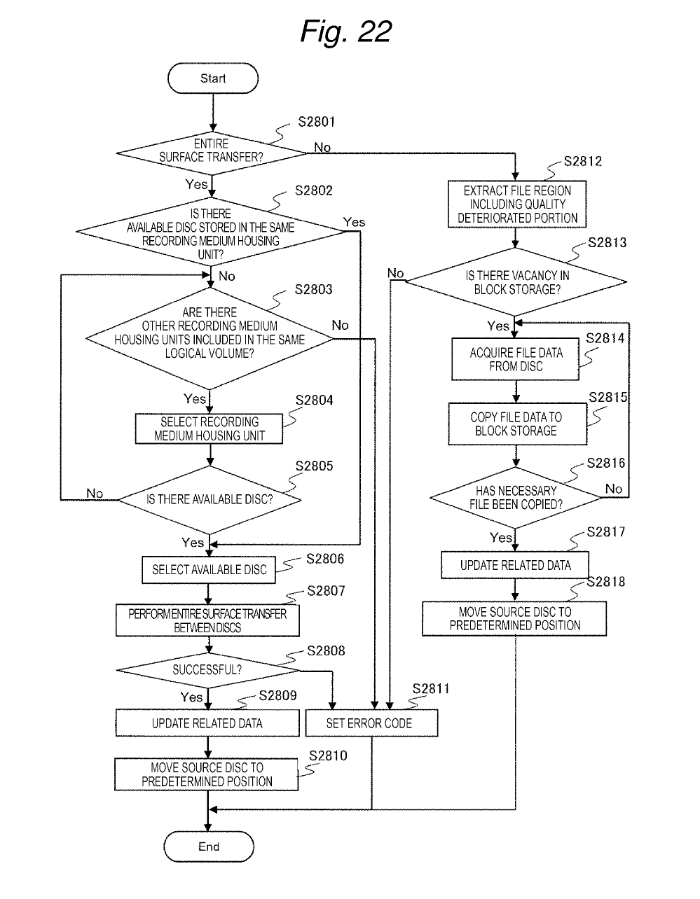

FIG. 22 illustrates a flow of a data transfer process performed in the server 100.

The data transfer control unit 217 checks whether a data transfer method for which an instruction is given by the quality inspection control unit 215 is transfer of data on the optical disc entire surface or transfer of data of a predetermined portion (step S2801).

In a case of the transfer of data on the optical disc entire surface, it is determined whether or not there is an unused optical disc in the recording medium housing unit 111 housing the optical disc (step S2802).

As a result of the determination, if there is the optical disc 113, the process proceeds to step S2806. If there is no unused optical disc, it is determined whether or not there is other recording medium housing units 111 which belong to the same logical volume (for example, a logical space or a name space corresponding to one tenant among multiple tenants, or a logical space virtually allocated to a user) (step S2803).

If there is no recording medium housing unit 111 belonging to the same logical volume in step S2803, the process proceeds to step S2811. If there are one or more recording medium housing units 111, any recording medium housing unit 111 is selected therefrom (step S2804).

After the recording medium housing unit 111 is selected in step S2804, it is determined whether or not there is an unused optical disc 113 in the recording medium housing unit 111. If there is no unused optical disc 113, the process proceeds to step S2803, and another recording medium housing unit 111 is selected (step S2805).

If there are one or more unused optical discs 113 in steps S2802 and 2805, any one of the optical discs is selected (step S2806).

Thereafter, the data transfer control unit 217 selects the data recording/reproducing units 110 which respectively load the deteriorated optical disc and the unused optical disc selected in step S2806, and requests the library control unit 211 to cause the data recording/reproducing units 110 to load the optical discs. The library control unit 211 transmits an optical disc loading request to the portable recording apparatus 103 via the library I/F unit 203. If information indicating that loading of the optical discs is completed is received from the portable recording apparatus 103, the data transfer control unit 217 gives an instruction to the portable recording apparatus 103 via the library control unit 211 so that the data on the deteriorated optical disc is written to the unused optical disc selected in step S2806. The portable recording apparatus 103 reads the data on the deteriorated optical disc in the predetermined block unit, and records the data to the unused optical disc (step S2807).

Here, in a case where optical discs as a transfer source and a transfer destination are present in the same portable recording apparatus 103, data read from the transfer source disc in the block unit is stored in the memory 105, and the data is written to the transfer destination disc. On the other hand, in a case where two optical discs are respectively present in different portable recording apparatuses 103 (1) and 103 (2), data on a transfer source disc in the block unit of the portable recording apparatus 103 (1) is read to the memory 105 of the portable recording apparatus 103 (1), and then the data is directly copied to the memory 105 of the portable recording apparatus 103 (2) without using the server 100, or the data is transmitted and received via the server I/F units of both the apparatuses. Alternatively, after the data may be read to the memory 105 of the portable recording apparatus 103 (1), the data may be temporarily copied to the memory 202 of the server 100 and may then be copied to the memory 105 of the portable recording apparatus 103 (2) from the server 100.

If transfer of all the data is completed between the transfer source disc and the transfer destination disc, it is determined whether or not the same content of the data on both the discs is present through comparison and thus the data transfer is successful. As a result, if the data transfer fails, the process proceeds to step S2811 (step S2808).

If the data transfer is successful in step S2808, the data transfer control unit 217 gives an instruction to the file management unit 207 via the control unit 201 so that the information pieces regarding the disc in use 1013, the magazine 1014, and the library 1015 of all files having under the current data transfer are updated in the data management table 1000. The data transfer control unit 217 gives an instruction to the configuration management unit 210 via the control unit 201 so that the attribute information 914 of the system management table 900, and the medium state 1805 regarding the transfer source disc and the transfer destination disc of the optical disc management table 1800 is updated. The data transfer control unit 217 gives an instruction to the portable recording apparatus 103 via the library control unit 211 so that the medium state 713 of the recording medium housing table 700 of the storage unit 112 is updated (step S2809).

Thereafter, the data transfer control unit 217 gives an instruction to the portable recording apparatus 103 via the library control unit 211 so that both of the transfer source disc and the transfer destination disc are moved to the original positions. Here, the transfer source disc becomes an unnecessary disc and may thus be moved to a location for easy disc exchange in the recording medium housing unit 111. The transfer source disc may be put into the data recording/reproducing unit 110, and may be discharged out of the data recording/reproducing unit 110 in response to an instruction for extraction from the user or the manager via the user I/F unit 209 in this state (step S2810).

On the other hand, if data of only the predetermined portion is transferred instep S2801, a file region and a size thereof corresponding to a location where quality deterioration is recognized are extracted in the same manner as in step S2708 of FIG. 21 (step S2812).

The data transfer control unit 217 determines whether or not the size extracted in step S2812 is present as an available region in the block storage 101. As a result, if there is no available region in the block storage 101, the process proceeds to step S2811 (step S2813).

If there is an available region in the block storage 101 in step S2813, the data transfer control unit 217 gives an instruction to the portable recording apparatus 103 via the library control unit 211 so that the transfer source disc is loaded to a predetermined data recording/reproducing unit 110. The data transfer control unit 217 gives an instruction to the portable recording apparatus 103 via the library control unit 211 so that file portions on the transfer source disc, extracted in step S2812, are sequentially read (step S2814).

The content of the files read from the portable recording apparatus 103 in step S2814 is received via the library I/F unit 203, and is recorded in a predetermined location of the block storage 101 (step S2815).

It is checked whether or not all the files extracted in step S2812 are recorded in the block storage 101, and if the files are being recorded, the process proceeds to step S2814 (step S2816).

If the transfer of all the data is completed, related data is updated in the same manner as in step S2809 (step S2817).

Thereafter, the transfer source disc is moved to a predetermined location in the same manner as in step S2810 (step S2818).

Finally, the data transfer control unit 217 notifies the quality inspection control unit 215 whether or not the data transfer is successful.

Here, a description will be made of a transfer process after the data is recorded in the block storage 101 in step S2815.

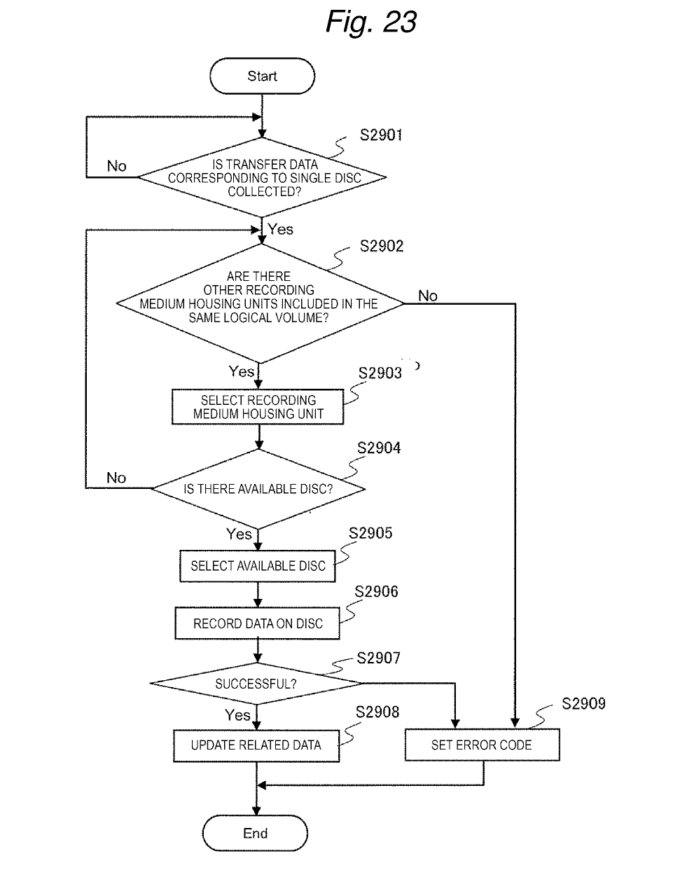

FIG. 23 illustrates a flow of a data transfer process performed in the server 100.

In a case where a file is recorded in the block storage 101 in step S2815 of FIG. 22, a storing destination of transferred data includes (1) a folder which stores an archive file which is received from the application server 20 via the host I/F unit 205 in the block storage 101, and (2) a folder used for transferred data only. The data may be stored in either (1) or (2), and (1) and (2) may be separately used. For example, a file whose data is required to be transferred in a relatively short period of time from recording of the data on an optical disc is recorded in the above (1), and a file whose data is required to be transferred after a long period of time elapses from recording of the data on an optical disc is recorded in the above (2). In addition, storing folders may be separately used on the basis of the type of file or a period for preservation.

As described above, after the data is copied to a predetermined folder in the block storage 101, the data transfer control unit 217 or the control unit 201 monitors whether or not the data in the predetermined folder reaches a capacity corresponding to a single optical disc. The recording condition in step S1602 of FIG. 16 may be used (step S2901).

If the data reaches the capacity corresponding to a single optical disc in step S2901, the data transfer control unit 217 or the control unit 201 determines whether or not there is the recording medium housing unit 111 included in the same logical volume. If there is no corresponding recording medium housing unit 111, the process proceeds to step S2909 (step S2902).

If there are one or more recording medium housing units 111 in step S2902, any one of the recording medium housing units 111 is selected (step S2903).

Thereafter, it is determined there is an unused optical disc 113 in the recording medium housing unit 111 selected in step S2903, and if there is no recording medium housing unit 111, the process proceeds to step S2902 so that another recording medium housing unit 111 is selected (step S2904).

If there are one or more unused optical discs 113 in step S2904, any one of the optical discs 113 is selected (step S2905).

The data recording/reproducing unit 110 used for recording is selected, and an instruction is given to the portable recording apparatus 103 via the library control unit 211 so that the optical disc 113 selected in step S2905 is inserted into the data recording/reproducing unit 110. The portable recording apparatus 103 is instructed to record transmitted data via the library control unit 211. Successively, the data in the predetermined folder is sequentially read from the block storage 101 via the disk I/F unit 204, and the data read from the library I/F unit is transmitted via the library control unit 211. The control unit 104 of the portable recording apparatus 103 delivers the data which is received via the server I/F unit 107, to the data recording/reproducing unit 110. The data recording/reproducing unit 110 sequentially records the received data on the optical disc (step S2906).

If recording of all the data is completed in the data recording/reproducing unit 110, the data in the block storage 101 is compared with the data recorded on the optical disc so that both of the data items match each other. If both of the data items do not match each other, or if an error occurs during recording of the data, the process proceeds to step S2909 (step S2907).

If the data in the block storage 101 matches the data recorded on the optical disc in step S2907, the data related to the recorded data is updated in the various tables in the same manner as in step S2809 or S2817 of FIG. 22 (step S2908).

Here, if there is no appropriate recording medium housing unit in step S2902 or recording of the data fails in step S2907, an error code is set, and the data transfer control unit 217 or the control unit 201 notifies the quality inspection control unit 215 of the error code (step S2909).

Herein, the transfer process after the data is recorded in the block storage 101 in step S2815 has been described by using an example in which, if the file portion on the transfer source disc extracted in step S2812 reaches the capacity corresponding to a single optical disc, the data is recorded on a new optical disc.

However, there may be a case where all the data on the source disc is transferred before the extracted file portion reaches the capacity corresponding to a single optical disc. In this case, if the extracted file of the source disc cannot be recovered, all the data may be reproduced by using the extracted file portion recorded in the block storage 101. In other words, in a case where all the data on the optical disc on which some of the data has been copied is transferred to another optical disc, some of the data stored in the block storage 101 may be reproduced and may be transferred to another optical disc along with the data reproduced from the optical disc. Consequently, for example, even in a case where the number of deteriorated portions increases due to a certain factor and thus all data on an optical disc is suddenly required to be transferred in the optical disc in which partial deterioration occurs due to an accidental factor such as damage or dust, it is possible to realize rapid transfer of data without damaging the data.

FIG. 24 illustrates a configuration example of a quality inspection information table which is preserved in the memory 202 or the block storage 101 by the quality inspection control unit 215 of the server 100.

The quality inspection is performed according to the procedure illustrated in FIG. 20, and data is transferred. Thereafter, the quality inspection control unit 215 records the quality inspection result in the quality inspection information table 3000 as the history information.

The quality inspection information table 3000 includes the inspection date 3001, an inspection range 3002, an inspection drive 3003, an inspection value 3004, a result 3005, the temperature 3006, and a transferred capacity 3007.

The inspection date 3001 is the date on which the quality inspection control unit 215 of the server 100 or the quality inspection execution unit 119 of the portable recording apparatus 103 performed the quality inspection.

The inspection range 3002 indicates an inspection region on which an instruction for the quality inspection given by the quality inspection information management unit 515 of the apparatus management server 50 or the quality inspection control unit 215 of the server 100 is performed. In a case where all data on an optical disc is inspected, the “entire surface” is written, and in a case where partial inspection is performed, a “predetermined portion” is written.

The inspection drive 3003 indicates the data recording/reproducing unit 110 used for the quality inspection by the quality inspection execution unit 119 of the portable recording apparatus 103.

The inspection value 3004 indicates a result obtained by the quality inspection execution unit 119 of the portable recording apparatus 103 performing the quality inspection. For example, there is R-SER, or an average value, the maximum value, and the minimum value of the number of bytes of burst errors occur. In addition, an inspection value for each of the inspection regions 2401 to 2405 illustrated in FIG. 18 is written.

A result analyzed by the quality result analysis unit 216 is written into the result 3005. For example, “favorable”, “standard or less”, “partial transfer necessary”, “entire surface transfer necessary”, and “entire surface inspection necessary” are written.

The temperature 3006 indicates the environmental temperature acquired by the quality inspection control unit 215 in step S2701 of FIG. 21.

The transferred capacity 3007 indicates a capacity of data which is transferred by the data transfer control unit 217. In a case where data of the entire surface of a single optical disc is transferred, 100% is written. In a case where data is partially transferred, a ratio of an amount of transferred data to an amount of all data is written.

Regarding a location where the quality inspection information table 3000 is stored, the quality inspection information table 3000 is stored in the quality management 1809 of the optical disc management table 1800.

Through the above-described procedure, the quality inspection control unit 215 of the server 100 periodically performs quality inspection on a predetermined optical disc 113 in response to an instruction given by the apparatus management server 50. The quality inspection fundamentally targets only a predetermined inspection region of an optical disc, and it is determined whether or not the quality inspection is performed on the entire surface of the optical disc through analysis of the inspection result. Consequently, it is possible to reduce time required to perform quality inspection.

It is determined whether data of the entire surface of the optical disc is transferred to a new storage or only a file portion corresponding to a deteriorated portion is transferred through analysis of the quality inspection result. Consequently, it is possible to reduce time required to perform quality inspection and thus to prevent unnecessary use of an optical disc.

The quality inspection on the optical disc entire surface (for example, “regions of all data on the optical disc are set as inspection regions”) described in the present specification and the claims is not limited to inspection of accurately all data recorded on the optical disc. In other words, inspection regions including regions other than at least a partial predetermined inspection region may be set. For example, a case where quality of all data recorded in the management information region is inspected, a case where quality of all data recorded in the user data region is inspected, and a case where quality of all the data of both of the regions is inspected can also be included in the concept of the “entire surface” quality inspection.

Here, the quality inspection information management unit 515 and the quality inspection schedule generation unit 516 of the apparatus management server 50 may be mounted in the server 100 of the data library system 10, and, in this case, the server 100 generates and/or manages a quality inspection schedule, gives an instruction for measuring the temperature, and determines a quality inspection cycle instead of the apparatus management server 50.

### EXAMPLE 2

In Example 1, the methods of efficiently performing quality inspection and transfer of data have been described. In the present example, a description will be made of a method of checking a data transfer situation in an optical disc in which the data is recorded, or a capacity change on the optical disc on which the data has been transferred as necessary, by a user or a manager using the apparatus management server 50.

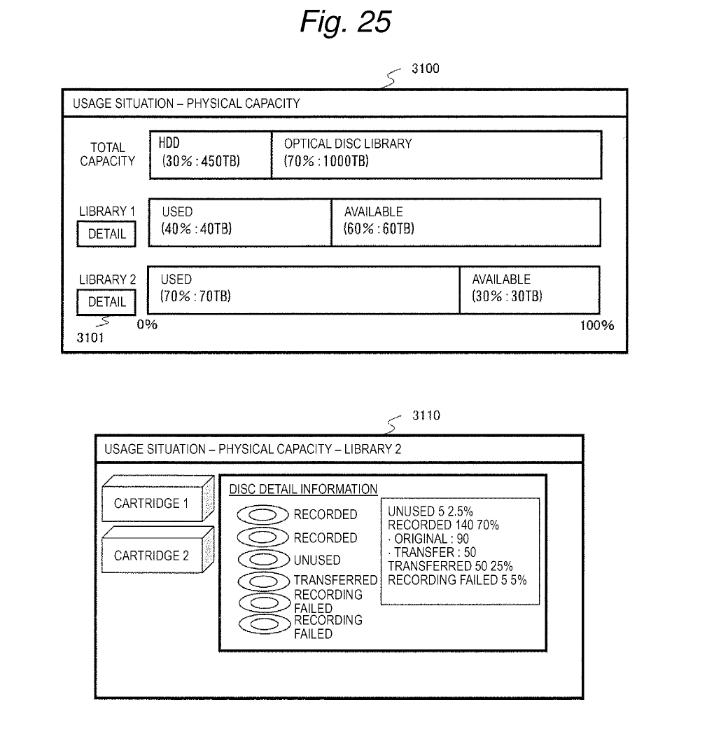

FIG. 25 illustrates a configuration example of a screen displayed by the apparatus management server 50 in a case where the user or the manager instructs the apparatus management server 50 to display a usage situation of a data library system 10 via the user I/F unit 503.

The control unit 501 of the apparatus management server 50 having received an instruction from the user or the manager refers to the apparatus configuration management table 1400 managed by the configuration management unit 510 and the capacity management table 1500 managed by the capacity management unit 511, and displays the capacities in use of the block storage 101 and the portable recording apparatus 103 of the data library system 10 on a screen 3100 of the display device 102 via the external display control unit 508.

A total capacity on the screen 3100 indicates the loading capacities of the block storage 101 and the portable recording apparatus 103 included in the data library system 10.

A library 1 and a library 2 on the screen 3100 indicate the capacity of the portable recording apparatus 103. A capacity used to record data on an optical disc is indicated by “used”, and an unused capacity is indicated by “available”.

A [detail] button 3101 is displayed for each library displayed on the screen 3100. If the user or the manager gives an instruction for the [detail] button 3101 via the user I/F unit 503, the control unit 501 of the apparatus management server 50 displays a screen 3110 which displays detail information regarding a selected library, on the display device 102 via the external display control unit 508.

The screen 3110 displays one or more recording medium housing units 111 (a cartridge 1 and a cartridge 2 on the screen 3110) which are set in the portable recording apparatus 103 indicated by the library on the left side. Information regarding all optical discs housed in each recording medium housing unit 111 is displayed on the right side. For example, a state (recorded, unused, recording failed, transferred, or the like) of each optical disc is displayed, and, among the total number of discs, a proportion or the number of discs having each state is displayed in summary.

As described above, the user or the manager checks the screens 3100 and 3110 and can thus understand the history of a used optical disc, for example, the number of optical discs in which recording has failed or the number of optical discs in which data has been transferred so as to specify whether capacity consumption is caused by a problem during recording or by a problem such as quality deterioration. For example, in a case where a proportion of optical discs in which recording has failed is high among used optical discs, or in a case where a proportion of discs which become unnecessary in a state in which data has been transferred, it is possible to understand that an amount of data to be transferred may increase and thus optical discs for transfer may be insufficient.

Here, the capacity computation execution unit 514 of the apparatus management server 50 may calculate the time at which the current available capacity becomes insufficient by using an actual change in the capacity in use of the data library system 10 and an actual change in the capacity in use of an optical disc on which data has been transferred, and may update a capacity adding schedule on the basis thereof.

Not only the user or the manager but also a maintenance worker may display the screen 3100 or the screen 3110 by using the maintenance server 60. In a case where the maintenance worker instructs the maintenance server 60 to display a usage situation of the data library system 10 via a user I/F unit, a control unit of the maintenance server 60 notifies a deterioration information management unit thereof. The deterioration information management unit acquires the system management table 900, the apparatus configuration management table, or the capacity management table 1500 from any one of the apparatus management server 50, and the server 100 and the portable recording apparatus 103 of the data library system 10 via a maintenance I/F unit, so as to display the screens. The maintenance worker checks the screens 3100 and 3110 and can thus understand a deterioration situation of an optical disc so as to set periodic maintenance execution time or to make a plan to exchange discs.

### EXAMPLE 3

In the present example, a description will be made of a method in which the maintenance worker recognizes a deterioration situation of an optical disc on which data is recorded by using the maintenance server 60.

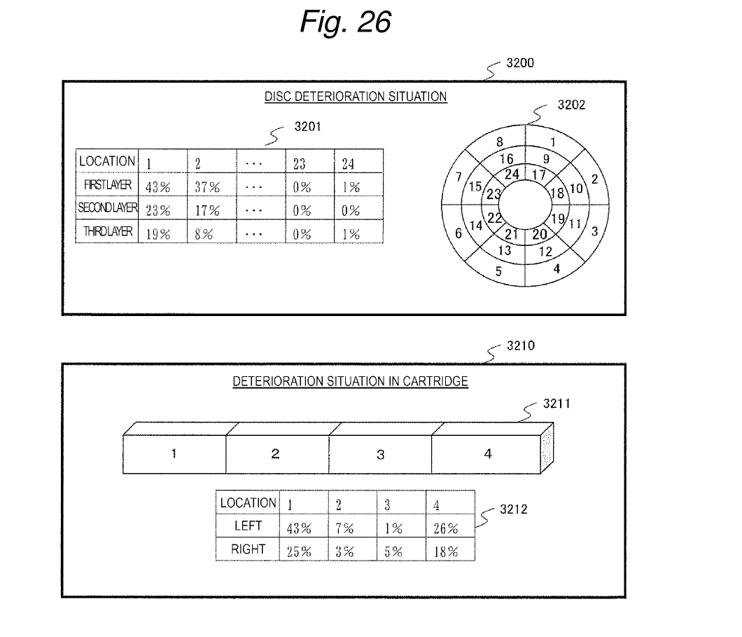

FIG. 26 illustrates a configuration example of a screen displayed by the maintenance server 60 in a case where the maintenance worker instructs the maintenance server 60 to display a deterioration situation of an optical disc of the data library system 10 via the user I/F unit.

The control unit of the maintenance server 60 having received an instruction from the maintenance worker acquires the content of the quality inspection information table 3000 or the optical disc management table 1800 from the server 100 or the portable recording apparatus 103 of the data library system via the maintenance I/F unit. On the basis of the acquired content, statistical information regarding a location where quality is deteriorated, for example, a disc position (a slot number or the like) in the recording medium housing unit 111 or positions (2401 to 2405 illustrated in FIG. 18) on the optical disc 113 is calculated and is displayed on screens 3200 and 3210 of the display device 102 via an external display control unit 607.

The screen 3200 includes a region image 3202 in which the optical disc 113 is divided into any blocks, and a deterioration situation table 3201 showing a deterioration ratio in each region. The maintenance worker can recognize a portion which is easily deteriorated on the optical disc 113 in the data library system 10 from the screen 3200, and can thus take a countermeasure such as preventing data from being recorded on the easily deteriorated portion or incorporating a mechanism which does not cause damage on an optical disc into the recording medium transport unit 114.

The screen 3210 shows the deterioration degree of the optical disc 113 disposed at a location of the recording medium housing unit 111 of the data library system 10. The screen 3210 includes a region image 3211 in which the recording medium housing unit 111 is divided into any blocks, and a deterioration situation table 3212 showing a deterioration ratio in each region. The maintenance worker can recognize a location where an optical disc is easily deteriorated in the recording medium housing unit 111 from the screen 3210 and can thus take a countermeasure such as resistant to dust or uniformization of the environmental temperature.

What is claimed is:

1. A data archive system comprising:
a library apparatus that records and reproduces data on and from a plurality of recording media; and
a server that manages the library apparatus,
wherein the library apparatus includes
a recording medium housing unit that houses a plurality of recording media;
a recording/reproducing unit that records and reproduces data on and from the recording medium;
a recording medium transport unit that transports the recording medium between the recording/reproducing unit and the recording medium housing unit;
a server interface that transmits and receives information to and from the server; and
wherein the server includes
a controller that controls the library apparatus;
a host interface that transmits and receives data to and from a high order host;
a library interface that transmits and receives information to and from the library apparatus; and
a data storing unit that stores data which is transmitted to and received from the host I/F unit and the library I/F unit, and
wherein the control unit of the server
inspects quality of recorded data on the recording medium,
determines whether quality inspection is performed on the entire surface of a recording medium housed in the recording medium housing unit or on a predetermined inspection region of the recording medium as an inspection range for inspecting recording quality of data recorded on the recording medium of the library apparatus,
transmits a quality inspection execution request to the quality inspection execution unit of the library apparatus via the library I/F unit, and
determines whether all data on the recording medium is transferred or some data is transferred as a transfer range in which the data is transferred on the basis of a result of the quality inspection which is received via the library I/F unit.

2. The data archive system according to claim 1,
wherein the control unit of the server
inspects a predetermined inspection region of the recording medium as an inspection range for performing the quality inspection,
sets data corresponding to deteriorated regions as a transfer target in a case where the number of deteriorated regions in the inspection region is within a predetermined number, and
inspects again the entire surface of the recording medium as an inspection region in a case where the number of deteriorated regions exceeds the predetermined number.

3. The data archive system according to claim 2,
wherein the quality inspection unit of the server inspects again the entire surface of the recording medium as an inspection region in a case where the deteriorated region in the predetermined inspection region is generated on an outer circumferential side of the recording medium.

4. The data archive system according to claim 1,
wherein the control unit of the server
inspects the entire surface of the recording medium as an inspection range for performing the quality inspection,
sets data corresponding to deteriorated locations as a transfer target in a case where a total capacity of the data corresponding to the deteriorated locations is within a predetermined size, and
transfers all data in a case where the total capacity exceeds the predetermined size.

5. The data archive system according to claim 1,
wherein the control unit of the server determines whether the quality inspection is performed on the entire surface of the recording medium or on a predetermined inspection region of the recording medium on the basis of an elapsed period from the date on which data was recorded on the recording medium.

6. The data archive system according to claim 1,
wherein the library apparatus includes a thermometer, and
wherein the control unit of the server
instructs the library apparatus to measure the temperature,
determines a cycle of the quality inspection on the basis of the measured temperature, and
performs the quality inspection on a recording medium on which data is recorded in the library apparatus on the basis of the determined cycle.

7. The data archive system according to claim 6,
wherein the control unit of the server
holds a life prediction table showing a relationship between an elapsed period and quality deterioration of a recording medium on which data is recorded at a predetermined temperature, and
determines whether the quality inspection is performed on the entire surface of the recording medium or on a predetermined inspection region of the recording medium on the basis of a result of comparison with the content of the life prediction table by using an elapsed period from the date on which the data was recorded on the recording medium and the temperature measured by the thermometer.

8. The data archive system according to claim 6,
the control unit of the server updates the cycle of quality inspection which is determined on the basis of the measured temperature, by using a result of performing the quality inspection on the recording medium on which the data is recorded.

9. The data archive system according to claim 1,
wherein the control unit of the server controls the library apparatus so that the data is transferred to another recording medium in a case where all the data on the recording medium is transferred, and the data is copied to the data storing unit in a case where some of the data is transferred.

10. The data archive system according to claim 9,
wherein the control unit of the server controls the library apparatus and the data storing unit so that, in a case where all the data on the recording medium on which some of the data has been copied is transferred to another recording medium, some of the data stored in the data storing unit is reproduced and is transferred to another recording medium along with the data reproduced from the recording medium.

11. The data archive system according to claim 1,
wherein the control unit of the server
selects an unused recording medium as a transfer destination in a case where there is the unused recording medium in the recording medium housing unit when all the data on the recording medium is transferred,
selects an unused recording medium as a transfer destination in other recording medium housing units allocated to the same logical space as a logical space of the recording medium housing unit in a case where there is no unused recording medium in the recording medium housing unit, and
outputs a message indicating a case where there is also no unused recording medium in other recording medium housing units when the case occurs.
